(19) United States
(12) Patent Application Publication
(10) Pub. No.: US 2017/0280036 A1
(43) Pub. Date: Sep. 28, 2017

(54) IMAGING APPARATUS

(71) Applicant: HOYA CORPORATION, Tokyo (JP)

(72) Inventor: Takahiro MORINAGA, Tokyo (JP)

(73) Assignee: HOYA CORPORATION, Tokyo (JP)

(21) Appl. No.: 15/462,182

(22) Filed: Mar. 17, 2017

(30) Foreign Application Priority Data
Mar. 25, 2016 (JP) 2016-062603

(51) Int. Cl. H04N 5/232

(52) U.S. Cl. CPC H04N 5/2328

(57) ABSTRACT

An imaging apparatus includes a movable member which supports an imaging device, a supporter which supports the movable member in a manner to allow the movable member to spherically swing about a swing center on an optical axis of an optical system of the imaging device, and a driver which drives the movable member to perform an image-stabilizing operation. The supporter includes supported surfaces on the movable member at different circumferential positions, and support surfaces provided on the stationary member at different circumferential positions in the initial state, the supported surfaces being in slidable contact with the support surfaces. Each support surface defines a cylindrical surface having a central axis through the swing center in a direction orthogonal to the optical axis in the initial state, the cylinder having substantially the same radius as that of the spherical surface of an associated supported surface.

### BACKGROUND OF THE INVENTION

1. Field of the Invention

The present invention relates to an imaging apparatus equipped with an anti-shake (image shake correction/image stabilizing/shake reduction) system.

2. Description of the Related Art

Imaging apparatuses of recent years usually incorporate an anti-shake system for reduction of image shake caused by vibrations such as hand shake. Anti-shake systems detect vibrations applied to the imaging apparatus and/or variations in the orientation thereof, and shift an anti-shake optical element relative to the optical axis (i.e., move the anti-shake optical element in a plane orthogonal to the optical axis) or tilt the anti-shake optical element relative to the optical axis so as to cancel out the effect of the vibrations and the orientation variations. The anti-shake optical element comprises at least part (e.g., a lens group) of an imaging optical system or an image sensor.

Due to increased diversification of the use of imaging apparatuses, it has been required to improve the operation specifications (driving amount and flexibility in driving direction) of the anti-shake optical element. For instance, Japanese Unexamined Patent Publication No. 2013-246414 discloses a lens-unit support structure which supports a lens unit in a manner to allow the lens unit to spherically swing by making a spherical slide portion (convex spherical surface), surface), which is formed on the outer peripheral surface of the lens unit, and a spherical support portion (concave spherical surface), which is formed on the inner peripheral surface of a fixed member, in slidable contact with each other. Japanese Unexamined Patent Publication No. 2013-246414 further discloses another lens-unit support structure which supports a lens unit in a manner to allow the lens unit to spherically swing via a plurality of balls (spherical bodies) installed between the spherical slide portion and the spherical support portion. Making a lens unit spherically swing achieves an anti-shake driving operation which has a high degree of flexibility in driving direction and has a large large driving amount.

In the case of supporting the anti-shake optical element to be capable of spherically swinging, in a lens-unit support structure in which convex and concave spherical surfaces slide on each other, a problem exists with it being difficult to control positional accuracy of the components (surface accuracy of the spherical surfaces) because the spherical surfaces of the spherical slide portion and the spherical support portion are in surface contact with each other over a wide range. In addition, since the contact area between the spherical surfaces is great, the frictional force between the spherical surfaces tends to be great, which makes it difficult to achieve a high-response anti-shake driving operation, which is performed using a small and power-saving driving source.

In the aforementioned type of lens-unit support structure that uses a plurality of balls installed between the spherical slide portion and the spherical support portion, the contact area of the balls with the spherical slide portion of the lens unit and the spherical support portion of the fixed member is extremely small. Therefore, when a strong impact is applied to the imaging apparatus due to an accidental fall or the like, the forces received from the balls are locally concentrated, so that dents (pockmarks) are easily formed on the slide portion and the support portion, and accordingly, there is a possibility of an adverse effect being exerted on the support accuracy of the lens unit. Additionally, the lens-unit support structure is required to be managed so that the plurality of balls are held at appropriate positions between the spherical slide portion and the spherical support portion, and the degree of difficulty in setting the support accuracy of the lens unit and assembling of the lens unit is high.

### SUMMARY OF THE INVENTION

The present invention has been devised in view of the above described problems and provides an imaging apparatus which has a high degree of flexibility in operation of a movable member that holds an anti-shake optical element, and which is superior in anti-shake performance and also in operational smoothness, durability, productivity and maintainability of the structure which supports the movable member in a manner to allow the lens unit to spherically swing.

According to an aspect of the present invention, an imaging apparatus is provided, including a movable member configured to support at least a part of an imaging device for obtaining object images; a supporter configured to support the movable member in a manner to allow the movable member to spherically swing relative to a stationary member about a swing center on an optical axis of an optical system of the imaging device; and a driver configured to apply a driving force to the movable member to make the movable member spherically swing relative to the stationary member, about the swing center, to perform an image-stabilizing operation. The supporter includes supported surfaces formed on the movable member at different positions with respect to a circumferential direction about the optical axis in an initial state, in which the movable member is positioned at an initial position of the spherical-swinging operation with respect to the stationary member, each supported surface defining a portion of a spherical surface centered about the swing center; and support surfaces provided on the stationary member at different positions in the circumferential direction about the optical axis in the initial state, the supported surfaces being in slidable contact with the support surfaces, each support surface defining a portion of a surface of a cylinder having a central axis that passes through the swing center in a direction substantially orthogonal to the optical axis in the initial state, the cylinder having substantially the same radius as that of the spherical surface of an associated supported surface.

In an embodiment, an imaging apparatus is provided, including a movable member configured to support at least a part of an imaging device for obtaining object images; a supporter configured to support the movable member in a manner to allow the movable member to spherically swing relative to a stationary member about a swing center on an optical axis of an optical system of the imaging device; and a driver configured to apply a driving force to the movable member to make the movable member spherically swing relative to the stationary member, about the swing center, to perform an image-stabilizing operation. The supporter includes supported surfaces formed on the movable member at different positions with respect to a circumferential direction about the optical axis in an initial state, in which the movable member is positioned at an initial position of the spherical-swinging operation with respect to the stationary member, each supported surface defining a portion of a spherical surface centered about the swing center; and support surfaces provided on the stationary member at different positions in the circumferential direction about the optical axis in the initial state, each support surface including flat surface portions which are in slidable contact with associated one of the supported surfaces at different points in a direction of the optical axis in the initial state.

It is desirable for the flat surface portions of each support surface to include a pair of flat surface portions which are positioned substantially symmetrically with respect to a plane which passes through the swing center and is substantially orthogonal to the optical axis in the initial state.

It is desirable for the flat surface portions of each support surface further to include a third flat surface portion which is substantially parallel to the optical axis in the initial state and connects the pair of flat surface portions.

In an embodiment, an imaging apparatus is provided, including a movable member configured to support at least a part of an imaging device for obtaining object images; a supporter configured to support the movable member in a manner to allow the movable member to spherically swing relative to a stationary member about a swing center on an optical axis of an optical system of the imaging device; and a driver configured to apply a driving force to the movable member to make the movable member spherically swing relative to the stationary member, about the swing center, to perform an image-stabilizing operation. The supporter includes supported surfaces formed on the movable member at different positions with respect to a circumferential direction about the optical axis in an initial state, in which the movable member is positioned at an initial position of the spherical-swinging operation with respect to the stationary member, each supported surface defining a portion of a spherical surface centered about the swing center; and support surfaces provided on the stationary member at different positions in the circumferential direction about the optical axis in the initial state, the supported surfaces being in slidable contact with the support surfaces, each support surface defining a portion of a torus, the torus having a circular arc shape having substantially the same radius as that of the spherical surface of an associated supported surface in a plane including the optical axis in the initial state, and a circular arc shape having a greater radius than that of the spherical surface of the associated supported surface in a plane substantially orthogonal to the optical axis in the initial state.

It is desirable for three of the supported surfaces to be provided at different circumferential positions about the optical axis, and three of the support surfaces to be provided at positions corresponding to the different circumferential positions about the optical axis, wherein an interval between each of the different circumferential positions is within an angular range of 30° through 150° about the optical axis.

It is desirable for the supporter to include support members which are supported to be movable relative to the stationary member in a radial direction with respect to the optical axis in the initial state, the support member respectively provided with the support surfaces at radially inner ends in the radial direction; restrictors provided on the stationary member and each the support members to restrict radially inward movements of the support members beyond a support position at which the support surfaces support the supported surfaces in a manner to allow the movable member to spherically swing relative to the stationary member; and shock absorbers which bias the support members radially inwards to hold the support members at the support position and which absorb a load when the support members move radially outwards from the support position.

It is desirable for the supporter to include retainers which are positioned radially outside the support members, respectively, and supported to be movable relative to the stationary member in the radial direction; and an outer restricting portion which prevents the retainers from coming off radially outwards from the stationary member. The shock absorbers are held between the support members and the retainers and are made of a resilient material.

It is desirable for the stationary member to include a cylindrical portion centered on the optical axis in the initial state. The support members, the resilient members and the retainers are respectively positioned in through-holes which are formed through the cylindrical portion of the stationary member in the radial direction. The outer restricting portion includes a peripheral enveloping member which is supported outside the cylindrical portion of the stationary member to cover radially outer end openings of the through-holes.

It is desirable for each of the retainers to include a guide surface which produces a component of force that moves the each retainer radially inwards upon receiving a force in the optical axis direction in the initial state from the peripheral enveloping member.

It is desirable for the driver to include actuators respectively provided between the supported surfaces and the support surfaces at circumferential positions about the optical axis.

In an imaging apparatus according to the present invention, the movable member is supported to be capable of spherically rotating by the supported surfaces, each of which is provided on the movable member and is spherical in shape, and the support surfaces, each of which is provided on the stationary member; accordingly, the imaging apparatus has a high degree of flexibility in operation of the movable member and is superior in anti-shake performance. The support surfaces provided on the stationary member are configured to be smaller in contact area than the case where spherical surfaces are made in surface contact with the supported surfaces, thus being advantageous for reduction of sliding resistance and for easiness of accuracy control. Additionally, the support surfaces that are provided on the stationary member are configured so that load is not easily locally concentrated compared with the configuration in which balls are made in contact with the support surfaces, thus being advantageous in shock resistance. Accordingly, an imaging apparatus can be achieved in which operational smoothness, durability, productivity and maintainability of the structure which supports the movable member that is driven to spherically swing to reduce image shake are satisfied at a high level.

The present disclosure relates to subject matter contained in Japanese Patent Application No. 2016-62603 (filed on Mar. 25, 2016) which is expressly incorporated herein by reference in its entirety.

### BRIEF DESCRIPTION OF THE DRAWINGS

The invention will be described below in detail with reference to the accompanying drawings, in which:

FIG. 1 is a front perspective view of a first embodiment of an imaging apparatus according to the present invention, showing an outward appearance thereof;

FIG. 2 is a rear perspective view of the imaging apparatus;

FIG. 3 is a front elevational view of the imaging apparatus;

FIG. 4 is a rear elevational view of the imaging apparatus;

FIG. 5 is a view taken in the direction of the arrow V shown in FIG. 3;

FIG. 6 is a rear elevational view of the imaging apparatus, from which a back lid and an image sensor unit are removed for clarity of illustration;

FIG. 7 is a sectional view taken along the line VII-VII shown in FIG. 3;

FIG. 8 is a sectional view taken along the line VIII-VIII shown in FIG. 3;

FIG. 9 is a sectional view taken along the line IX-IX shown in FIG. 5;

FIG. 10 is an exploded front perspective view of the imaging apparatus;

FIG. 11 is an exploded rear perspective view of the imaging apparatus;

FIG. 12 is an exploded front perspective view of a movable unit that constitutes a component of the imaging apparatus;

FIG. 13 is an exploded front elevational view of the movable unit;

FIG. 14 is an exploded rear perspective view of the movable unit;

FIG. 15 is an exploded rear elevational view of the movable unit;

FIG. 16 is a front elevational view of the movable unit;

FIG. 17 is a rear elevational view of the movable unit;

FIG. 18 is a view taken in the direction of the arrow XVIII shown in FIG. 16;

FIG. 19 is a view taken in the direction of the arrow XIX shown in FIG. 16;

FIG. 20 is a view taken in the direction of the arrow XX shown in FIG. 16;

FIG. 21 is a view taken in the direction of the arrow XXI shown in FIG. 16;

FIG. 22 is an exploded front perspective view of a stationary unit that constitutes a component of the imaging apparatus;

FIG. 23 is an exploded front elevational view of the stationary unit;

FIG. 24 is an exploded rear perspective view of the stationary unit;

FIG. 25 is an exploded rear elevational view of the stationary unit;

FIG. 26 is a partially-exploded front perspective view of the stationary unit and a support structure, for a spherical-swinging operation;

FIG. 27 is a partially-exploded rear perspective view of the stationary unit and the support structure, for a spherical-swinging operation;

FIG. 28 is a perspective view of a support member of the first embodiment of the imaging apparatus, which constitutes an element of the support structure for spherical-swinging operation;

FIG. 29 is a perspective view of the support member shown in FIG. 28 of the first embodiment of the imaging apparatus, viewed from a different direction from that in FIG. 28;

FIG. 30 is a plan view taken in the direction of the arrow XXX shown in FIG. 28;

FIG. 31 is a view taken in the direction of the arrow XXXI shown in FIG. 28;

FIG. 32 is a front elevational view showing a state where a barrel holder that constitutes a component of the movable unit is supported by the three support members (only one of which is shown in FIG. 32) of the first embodiment of the imaging apparatus;

FIG. 33 is a view taken in the direction of the arrow XXXIII shown in FIG. 32;

FIG. 34 is a sectional view taken along the line XXXIV-XXXIV shown in FIG. 32;

FIG. 35 is a sectional view taken along the line XXXV-XXXV shown in FIG. 33;

FIG. 36 shows a view of a support member of a second embodiment of the imaging apparatus and a sectional view, similar to that of FIG. 34, showing a state where the barrel holder is supported by the three support members (only one of which is shown in FIG. 36);

FIG. 37 shows a view of one support member of a third embodiment of the imaging apparatus and a sectional view, similar to that of FIG. 34, showing a state where the barrel holder is supported by the three support members (only one of which is shown in FIG. 37);

FIG. 38 is a front elevational view, similar to that of FIG. 32, showing a state where the barrel holder is supported by three support members (only one of which is shown in FIG. 38) of the fourth embodiment of the imaging apparatus;

FIG. 39 is a view taken in the direction of the arrow XXXIX shown in FIG. 38;

FIG. 40 is a sectional view taken along the line XL-XL shown in FIG. 38; and

FIG. 41 is a sectional view taken along the line XLI-XLI shown in FIG. 39.

### DESCRIPTION OF THE EMBODIMENTS

An embodiment (first embodiment) of an imaging apparatus 10 according to the present invention will be discussed below with reference to the attached drawings. The imaging apparatus 10 is provided with an imaging optical system L and an image sensor unit 19 as components of an imaging device for obtaining object images. A one-dot chain line O shown in the drawings designates the optical axis of an imaging optical system L provided in the imaging apparatus 10. In the following descriptions, the optical axis direction refers to a direction along, or parallel to, the optical axis O (a direction in which the optical axis O and an extension line thereof extend, or a direction in which a straight line parallel to the optical axis O extends), “front” refers to the object side, and “rear” refers to the image side with respect to the optical axis direction. In addition, a radial direction refers to a radial direction from the optical axis O (the direction in which a straight line normal to and intersecting the optical axis O extends). An inward radial direction refers to a radial direction toward the optical axis O and an outward radial direction refers to a radial direction away from the optical axis O. Additionally, a circumferential direction refers to a circumferential direction about the optical axis O. The optical axis O refers to the optical axis O in the designed initial state of the imaging apparatus 10 (refers to the optical axis O at the initial position of a movable unit 11 relative to a stationary unit 18 in the following description), in which a tilting operation of the movable unit 17 and a lens barrel 11 (which is fixedly supported by the movable unit 17) with respect to the stationary unit 18 is not performed (i.e., an anti-shake driving operation is not performed), unless otherwise noted. The lens barrel 11, the movable unit 17 and the stationary unit 18 are components of the imaging apparatus 10 and will be discussed in detail later.

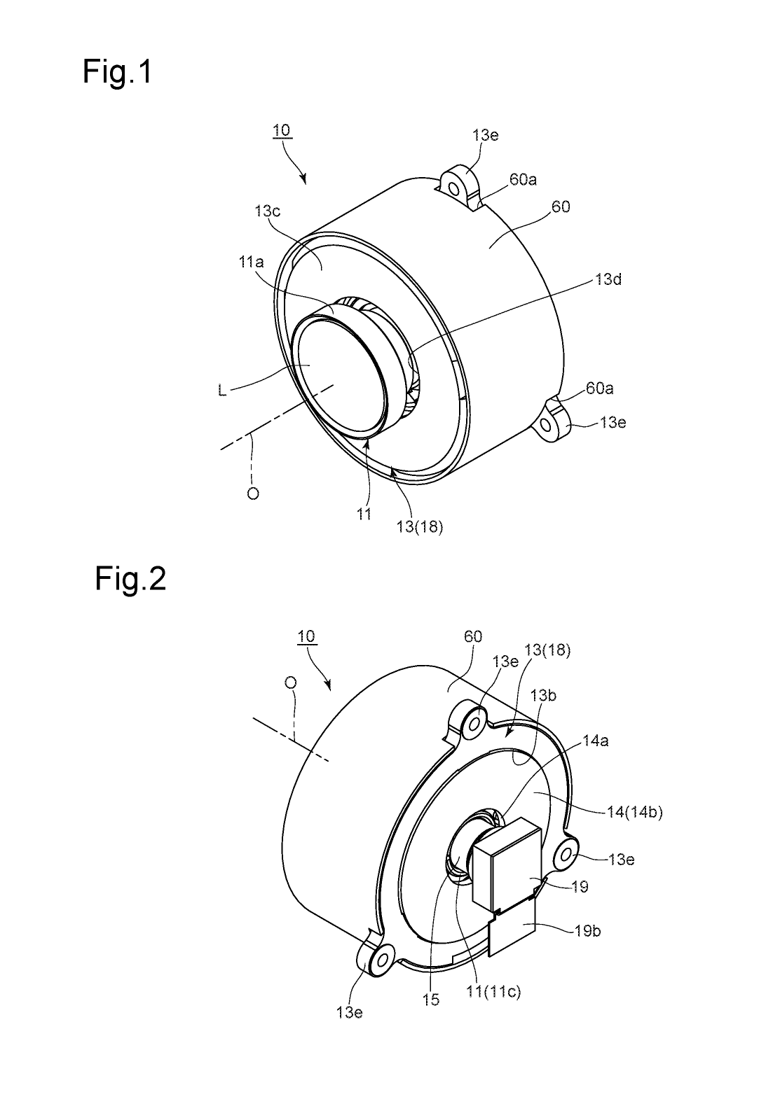

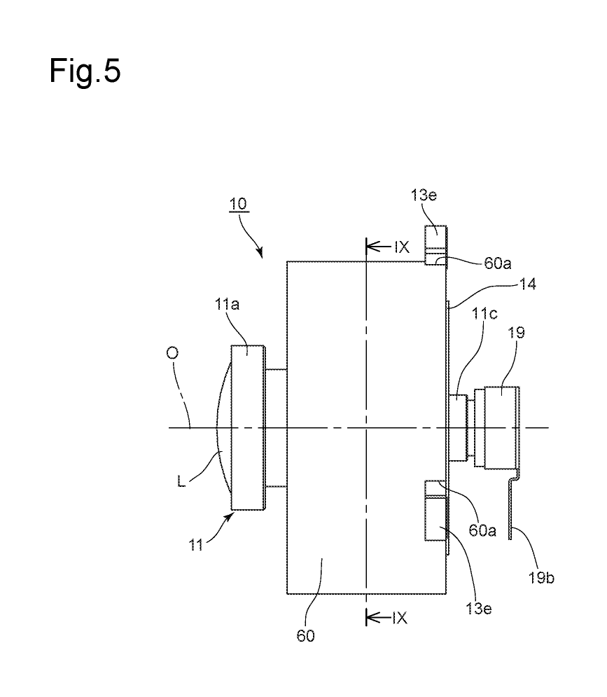

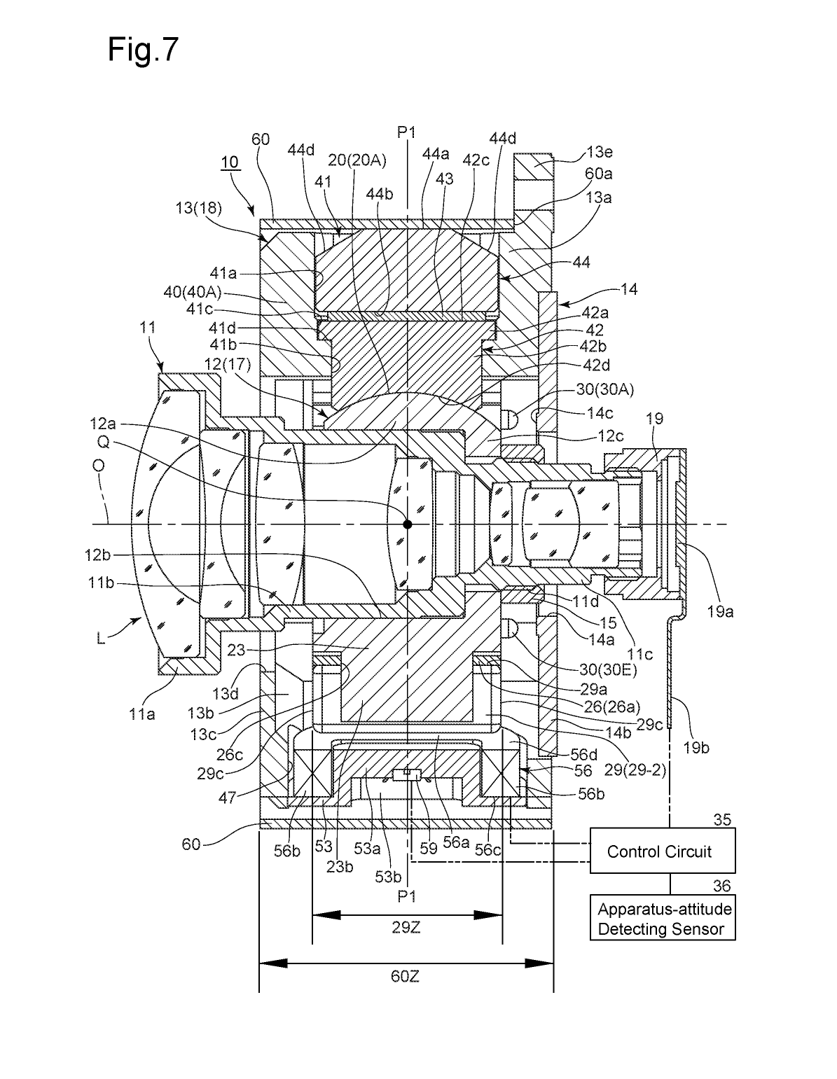

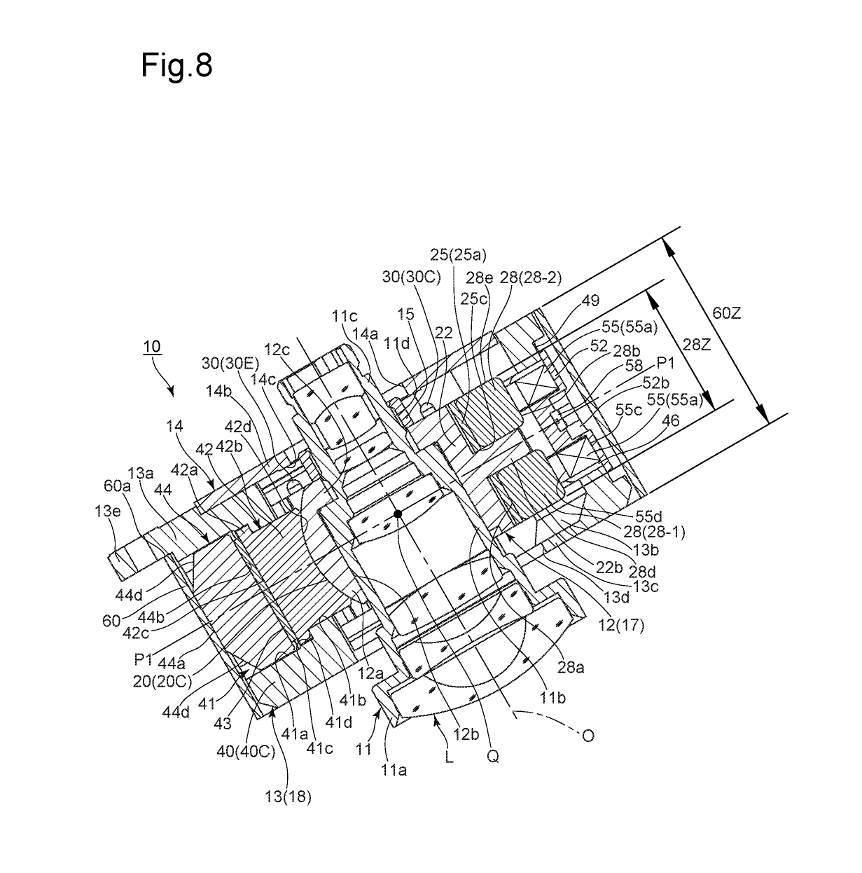

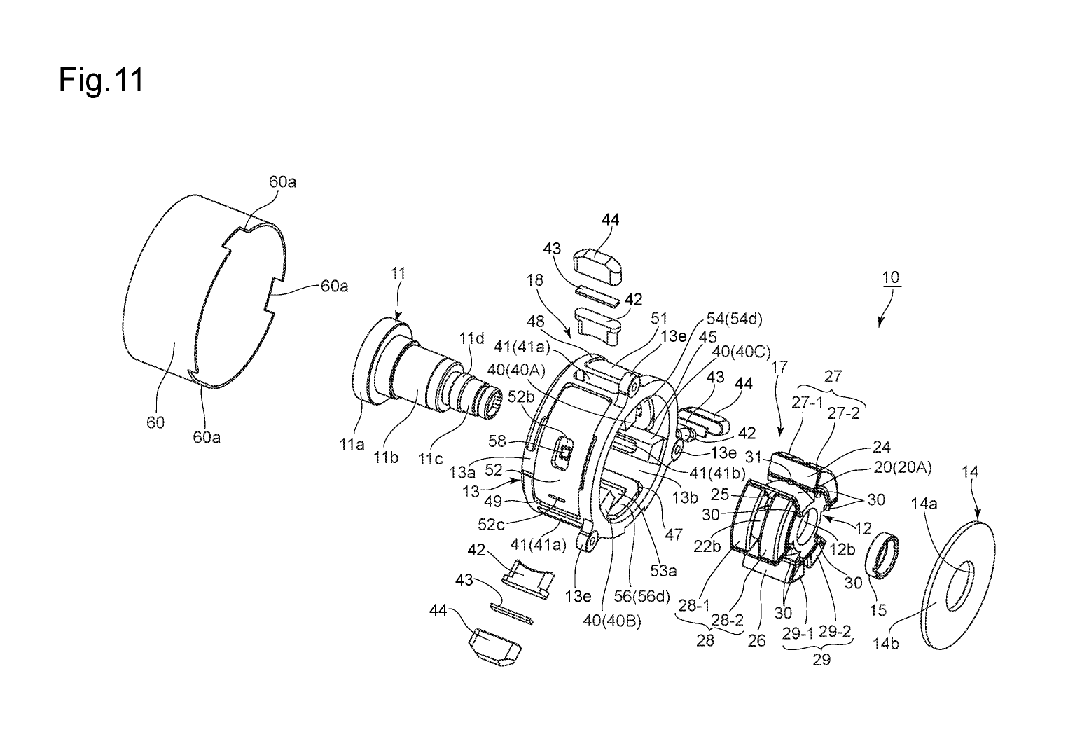

FIGS. 1 through 5 show the outward appearance of the imaging apparatus 10, viewed from different angles. As shown in FIGS. 7 through 11, the imaging apparatus 10 is provided with the aforementioned lens barrel 11 and a barrel holder (movable member) 12, into which the lens barrel 11 is inserted and supported thereby, and has a basic structure in which a combined body of the lens barrel 11 and the barrel holder 12 is movably supported in a housing including a coil holder (stationary member) 13 and a lid member 14. FIG. 7 shows a state where the image sensor unit 19 is mounted to the rear end of the lens barrel 11, whereas the image sensor unit 19 is not shown in FIG. 8.

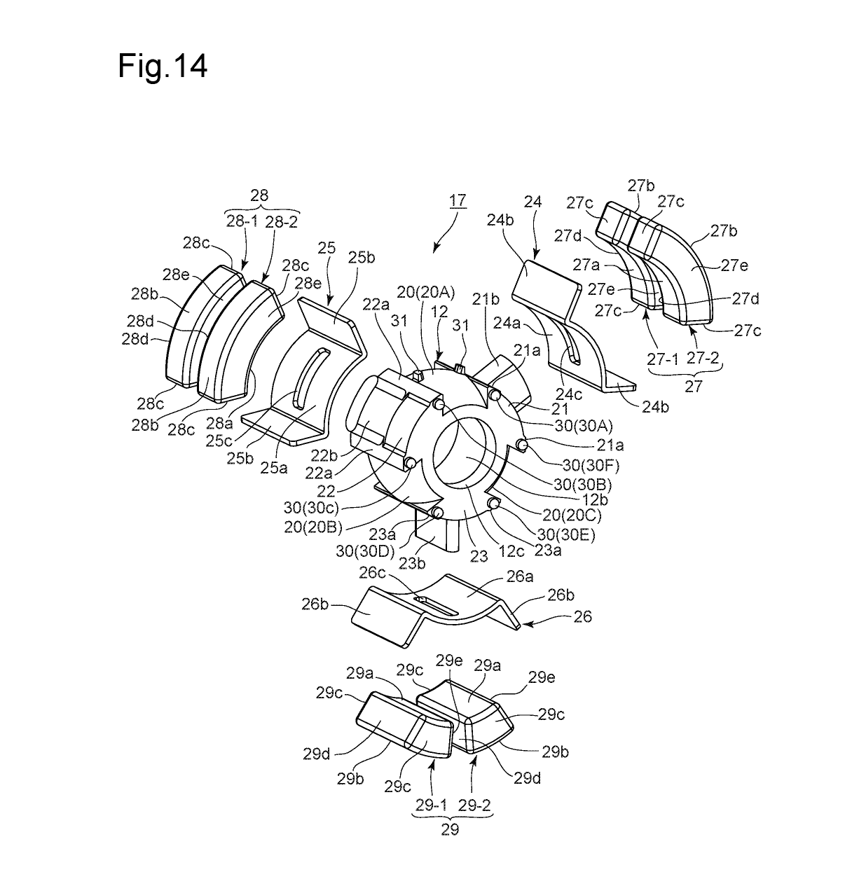

As shown in FIGS. 7 through 17, 32, 34 and 35, the barrel holder 12 is provided with a cylindrical portion 12a which surrounds the optical axis O and an axial through-portion 12b which is formed as a through-hole extending through the cylindrical portion 12a in the optical axis direction. The barrel holder 12 is provided in the vicinity of the rear end of the axial through-portion 12b with an insertion restriction flange 12c, having an annular shape and projecting radially inwards so as to reduce the inner diameter (aperture size) of the axial through-portion 12b.

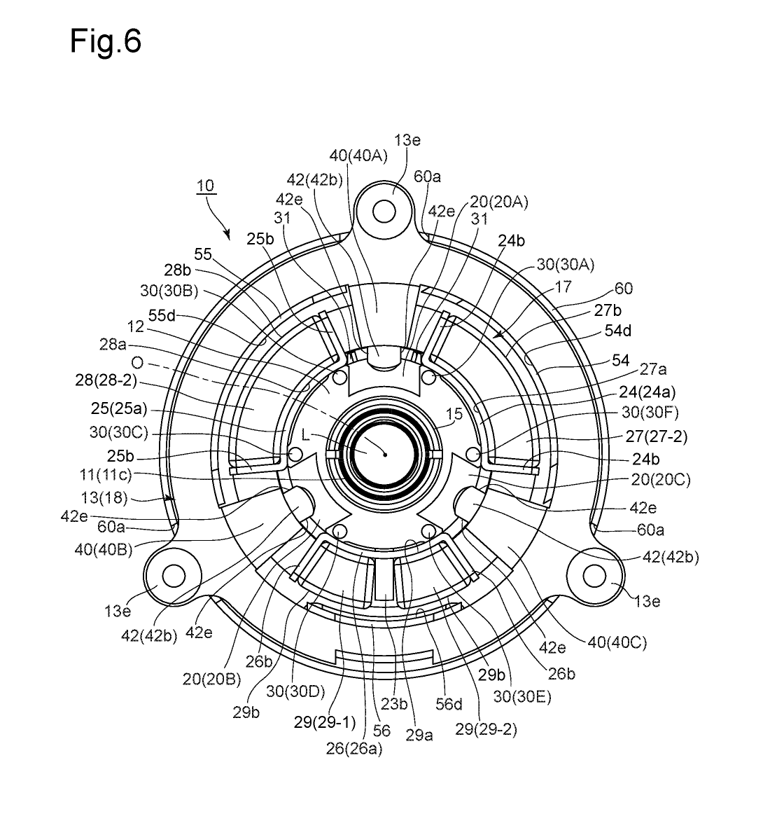

As shown in FIGS. 6 through 18 and 20, the barrel holder 12 is provided on the outer periphery of the cylindrical portion 12a thereof with three swing guide surfaces (supporters/supported surfaces) 20. The three swing guide surfaces 20 are formed at different positions in the circumferential direction and designated by reference marks 20A, 20B and 20C. Each of the three swing guide surfaces 20A, 20B and 20C constitutes a portion of the surface of a sphere that is centered on a predetermined point on the optical axis O, and the center of this sphere is referred to as the spherical-swinging center (swing center) Q (shown in FIGS. 7, 8 and 34). In other words, each of the three swing guide surfaces 20A, 20B and 20C defines a portion of a spherical surface centered about the spherical-swinging center (swing center) Q. The three swing guide surfaces 20A, 20B and 20c have substantially the same width in the circumferential direction and are arranged at substantially equi-angular intervals (intervals of 120 degrees) in the circumferential direction. An imaginary plane P1 which is substantially orthogonal to the optical axis O (the optical axis O in the aforementioned designed initial state of the imaging apparatus 10, in which the tilting operation of the movable unit 17 and the lens barrel 11 with respect to the stationary unit 18 is not performed) and passes through the spherical-swinging center Q is shown in FIGS. 7, 8 and 34.

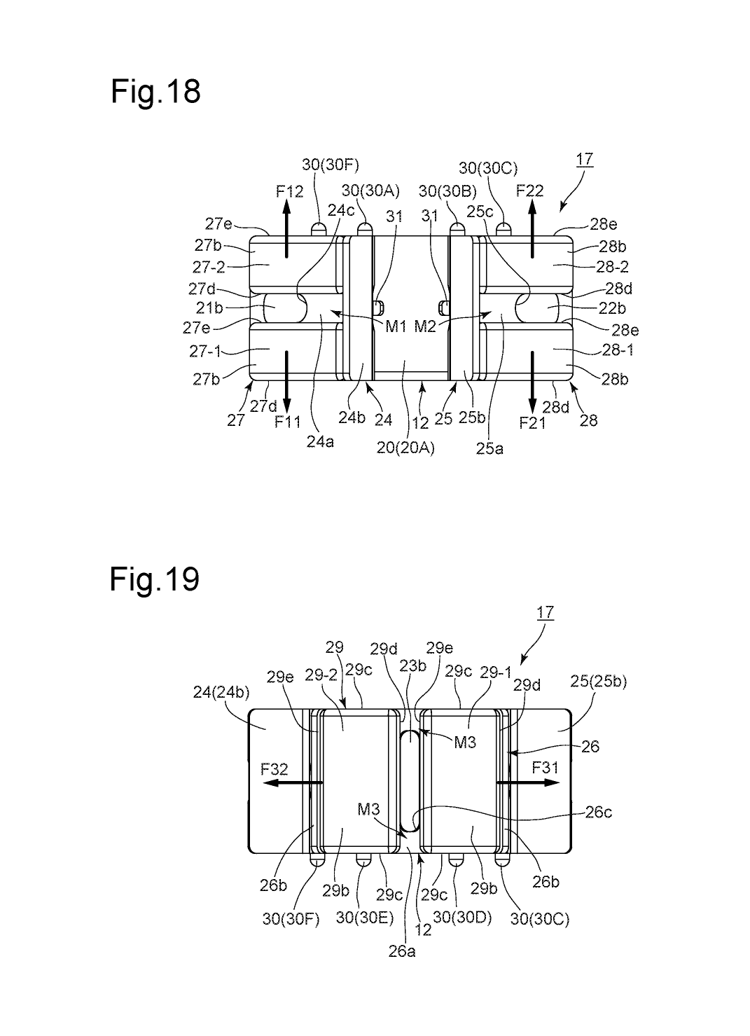

As shown in FIGS. 6 through 8, 11, 14, 15, 17 through 21, 33 and 34, the barrel holder 12 is provided, at the rear end surface thereof, with a plurality of tilting restriction projections 30 which project rearward in the optical axis direction. A total of six tilting restriction projections 30 are provided, specifically, the following three pairs of tilting restriction projections 30: a pair of tilting restriction projections 30A and 30B which are provided at positions at either side of the swing guide surface 20A in the circumferential direction, a pair of tilting restriction projections 30C and 30D which are provided at positions at either side of the swing guide surface 20B in the circumferential direction, and a pair of tilting restriction projections 30E and 30F which are provided at positions at either side of the swing guide surface 20C in the circumferential direction. The end of each tilting restriction projection 30 (i.e., the rear end thereof in the optical axis direction) is semispherical in shape, and all the six tilting restriction projections 30 project from the rear end surface of the barrel holder 12 by substantially the same amount (see FIGS. 18 through 21, 33 and 34).

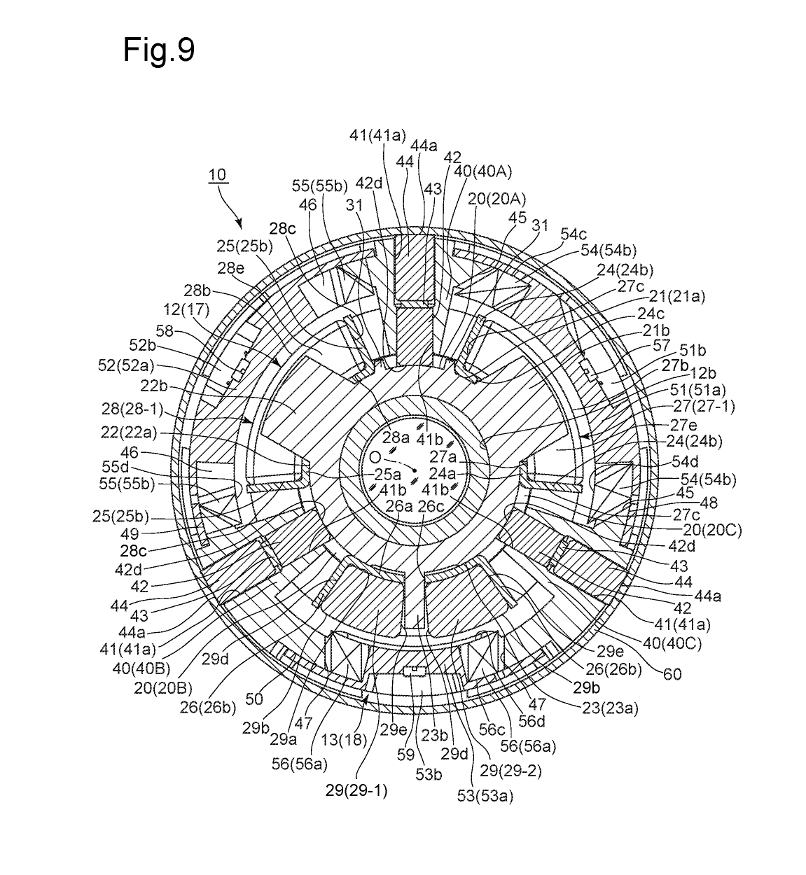

As shown in FIGS. 9 through 18, 21, 32 and 35, the barrel holder 12 is provided on the swing guide surface 20A with a pair of rolling-range limit projections 31 which are spaced from each other in the circumferential direction. The swing guide surface 20A, which is formed as a portion of the surface of a sphere centered on the spherical-swinging center Q, becomes increasingly distant from the optical axis O with respect to a direction from either end (front/rear end) of the swing guide surface 20A toward the center thereof (in the optical axis direction). The pair of rolling-range limit projections 31 are formed on the swing guide surface 20A at an approximate center thereof with respect to the optical axis direction which has the greatest distance from the optical axis O (i.e., formed to lie on the imaginary plane P1). In other words, the pair of rolling-range limit projections 31 is provided on an area of the swing guide surface 20A which projects radially outwards by the greatest amount.

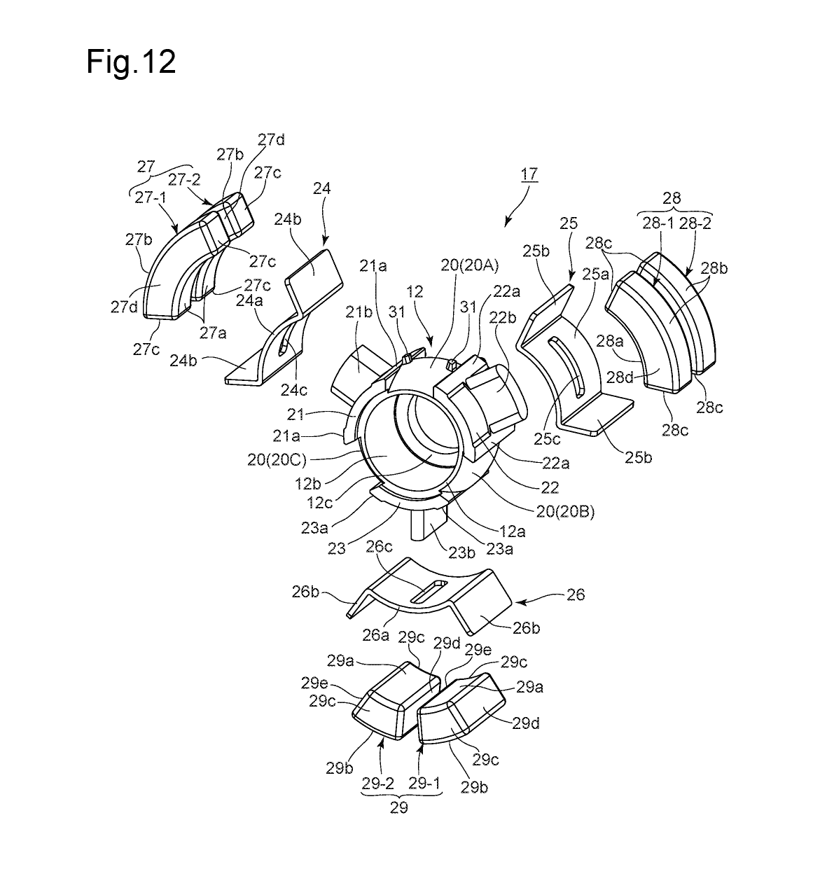

As shown in FIGS. 12 through 17, 32 and 33, the barrel holder 12 is provided with three support seats 21, 22 and 23 at positions between the three swing guide surfaces 20A, 20B and 20C in the circumferential direction. Specifically, the support seat 21 is positioned between the two swing guide surfaces 20A and 20C, the support seat 22 is positioned between the two swing guide surfaces 20A and 20B, and the support seat 23 is positioned between the two swing guide surfaces 20B and 20C.

The support seat 21 is provided with a pair of support surfaces 21a and a magnet support projection 21b. Each support surface 21a is formed as a cylindrical surface with the curvature center thereof located at the optical axis O, while the magnet support projection 21b projects radially outwards by an amount of projection greater than that of each support surface 21a. The support seat 22 is provided with a pair of support surfaces 22a and a magnet support projection 22b. Each support surface 22a is formed as a cylindrical surface with the curvature center thereof located at the optical axis O, while the magnet support projection 22b projects radially outwards by an amount of projection greater than that of each support surface 22a. The support seat 23 is provided with a pair of support surfaces 23a and a magnet support projection 23b. Each support surface 23a is formed as a cylindrical surface with the curvature center thereof located at the optical axis O, while the magnet support projection 23b projects radially outwards by an amount of projection greater than that of each support surface 23a. The pair of support surfaces 21a, the pair of support surfaces 22a and the pair of support surfaces 23a are portions of the same cylindrical surface. The pair of support surfaces 21a are provided at either end of the support seat 21 in the circumferential direction. The pair of support surfaces 22a are provided at either end of the support seat 22 in the circumferential direction. The pair of support surfaces 23a are provided at either end of the support seat 23 in the circumferential direction.

As shown in FIGS. 8 through 15, 18, 20, 21, 32, 33 and 35, the magnet support projection 21b and the magnet support projection 22b are plate-like projections which are small in thickness in the optical axis direction, the longitudinal direction of which substantially aligns with the circumferential direction and which are substantially identical in shape. The front surface and the rear surface of each of the two magnet support projections 21b and 22b in the optical axis direction are flat surfaces substantially parallel to each other and each formed into a flat surface lying in a plane substantially orthogonal to the optical axis O. The magnet support projection 21b is positioned at an approximate center of the support seat 21 in the optical axis direction. Likewise, the magnet support projection 22b is positioned at an approximate center of the support seat 22 in the optical axis direction. As shown in FIGS. 6, 7, 9, 12 through 17, 19 and 32 through 35, the magnet support projection 23b is a plate-like projection which is small in thickness in the circumferential direction, and the longitudinal direction of which substantially aligns with the optical axis direction. Both surfaces of the magnet support projection 23b (with respect to the circumferential direction) are flat surfaces which are substantially parallel to each other and elongated in the optical axis direction. The magnet support projection 23b is positioned at an approximate center of the support seat 23 in the circumferential direction.

The support seat 21 is provided with recessed portions (that are recessed radially inwards) which are positioned between the pair of support surfaces 21a in the circumferential direction and also positioned on the opposite sides of the magnet support projection 21b in the optical axis direction. The support seat 22 is provided with recessed portions (that are recessed radially inwards) which are positioned between the pair of support surfaces 22a in the circumferential direction and also positioned on the opposite sides of the magnet support projection 22b in the optical axis direction. The support seat 23 is provided with recessed portions (that are recessed radially inwards) which are positioned between the pair of support surfaces 23a in the circumferential direction and also positioned on the opposite sides of the magnet support projection 23b in the circumferential direction.

The bases of the three support seats 21, 22 and 23 except the magnet support projections 21b, 22b and 23b (i.e., the three pairs of support surfaces 21a, 22a and 23a of the three support seats 21, 22 and 23) are substantially identical in shape, and arranged at substantially equi-angular intervals (intervals of 120 degrees) in the circumferential direction. As shown in FIGS. 9 and 12 through 17, the imaging apparatus 10 is provided with three yokes 24, 25 and 26 which are mounted on the three support seats 21, 22 and 23, respectively, and are supported by the barrel holder 12. The yokes 24, 25 and 26 are made of a magnetic metallic material. The yoke 24 is provided with a curved base wall 24a which extends along the support surface 21a and a pair of standing walls 24b which project radially outwards from either end of the base wall 24a in the circumferential direction. Likewise, the yoke 25 is provided with a curved base wall 25a which extends along the support surface 22a and a pair of standing walls 25b which project radially outwards from either end of the base wall 25a in the circumferential direction, and the yoke 26 is provided with a curved base wall 26a which extends along the support surface 23a and a pair of standing walls 26b which project radially outwards from either end of the base wall 26a in the circumferential direction. The yoke 24 is provided in the base wall 24a with a slot 24c which is formed as a through-hole that is elongated in the circumferential direction, and the yoke 25 is provided in the base wall 25a with a slot 25c which is formed as a through-hole that is elongated in the circumferential direction, whereas the yoke 26 is provided in the base wall 26a with a slot 26c which is formed as a through-hole that is elongated in the optical axis direction. The slots 24c and 25c are shaped to allow the magnet support projection 21b and the magnet support projection 22b to be inserted therethrough, respectively, while the slot 26c is shaped to allow the magnet support projection 23b to be inserted therethrough. Each of the magnet support projections 21b, 22b and 23b is shaped in cross section to be inserted into the associated slot 24c, 25c or 26c without rattling. In this inserted state, the position of each yoke 24, 25 and 26 is determined with respect to the barrel holder 12 in both the optical axis direction and the circumferential direction. The three yokes 24, 25 and 26 are formed such that the base walls 24a, 25a and 26a are substantially identical in shape, that the pairs of standing walls 24b, 25b and 26b are substantially identical in shape, and with only the slot 26c being different in shape from the slots 24c and 25c.

As shown in FIGS. 9, 16 and 17, the three yokes 24, 25 and 26 are supported on the three support seats 21, 22 and 23 with the inner peripheral surfaces of the curved base walls 24a, 25a and 26a mounted onto the pairs of support surfaces 21a, 22a and 23a, respectively. In this state, the magnet support projections 21b, 22b and 23b project radially outwards through the slots 24c, 25c and 26c of the yokes 24, 25 and 26, respectively. With the yokes 24, 25 and 26 supported on the support seats 21, 22 and 23, the base walls 24a, 25a and 26a lie on an imaginary cylindrical surface centered on the optical axis O. As shown in FIGS. 7, 8 and 18 through 21, the yokes 24, 25 and 26 are substantially identical in length in the optical axis direction to the barrel holder 12. Additionally, in a state where the positions of the yokes 24, 25 and 26 relative to the barrel holder 12 are determined by engagement of the magnet support projections 21b, 22b and 23b in the slots 24c, 25c and 26c, respectively, the front edges of the yokes 24, 25 and 26 and the front end surface of the barrel holder 12 in the optical axis direction are positioned at the same position, with respect to the optical axis direction, and the rear edges of the yokes 24, 25 and 26 and the rear end surface of the barrel holder 12 are positioned at the same position with respect to the optical axis direction.

As shown in FIGS. 6, 8, 9 through 18, 20 and 21, the imaging apparatus 10 is provided with a first magnet unit (driver) 27 supported on the yoke 24 and a second magnet unit (driver) 28 supported on the yoke 25.

The first magnet unit 27 is configured of a set (pair) of circular-arc shaped permanent magnets (front and rear permanent magnets) 27-1 and 27-2 which are elongated in the circumferential direction. Likewise, the second magnet unit 28 is configured of a set (pair) of circular-arc shaped permanent magnets (front and rear permanent magnets) 28-1 and 28-2 which are elongated in the circumferential direction.

The permanent magnets 27-1 and 27-2 are identical in shape and size and are each provided with an inner peripheral surface 27a and an outer peripheral surface 27b. The inner peripheral surface 27a is a portion of an imaginary cylindrical surface centered on the optical axis O, while the outer peripheral surface 27b is a portion of an imaginary cylindrical surface which is centered on the optical axis O and is concentric with and greater in diameter than the imaginary cylindrical surface which includes the inner peripheral surface 27a. In addition, each of the permanent magnets 27-1 and 27-2 is provided with a pair of longitudinal end surfaces 27c which are positioned at either end with respect to the longitudinal direction of the permanent magnet (i.e., in the circumferential direction) and radially connect the inner peripheral surface 27a with the outer peripheral surface 27b, and a pair of side surfaces 27d and 27e which extend between the pair of longitudinal end surfaces 27c in the longitudinal direction of the permanent magnet (i.e., in the circumferential direction) and radially connect the inner peripheral surface 27a with the outer peripheral surface 27b.

The permanent magnets 28-1 and 28-2 are magnets identical in shape and size to the permanent magnets 27-1 and 27-2, thus being each provided with an inner peripheral surface 28a, an outer peripheral surface 28b, a pair of longitudinal end surfaces 28c and a pair of side surfaces 28d and 28e which respectively correspond to the inner peripheral surface 27a, the outer peripheral surface 27b, the pair of longitudinal end surfaces 27c and the pair of side surfaces 27d and 27e of each permanent magnet 27-1 and 27-2.

The first magnet unit 27 is mounted on the yoke 24 so that the permanent magnet 27-1 and the permanent magnet 27-2 are parallel-positioned side by side, with respect to the optical axis direction (the short-side direction of the permanent magnet 27-1 and the permanent magnet 27-2) on the front and rear of the yoke 24, respectively. As shown in FIGS. 9, 16 through 18 and 21, the inner peripheral surfaces 27a of the permanent magnet 27-1 and the permanent magnet 27-2 are mounted on the base wall 24a with the pair of longitudinal end surfaces 27c facing the pair of standing walls 24b. Since the inner peripheral surfaces 27a of the permanent magnet 27-1 and the permanent magnet 27-2 are curved surfaces along the base wall 24a, the permanent magnet 27-1 and the permanent magnet 27-2 are stably supported radially by engagement between the base wall 24a and the inner peripheral surfaces 27a. In addition, the positions of the permanent magnet 27-1 and the permanent magnet 27-2 in the circumferential direction are determined by the pair of standing walls 24b holding the permanent magnet 27-1 and the permanent magnet 27-2 from either side with respect to the circumferential direction (i.e., by the engagement of the pair of longitudinal end surfaces 27c of each permanent magnet 27-1 and 27-2 with the pair of standing walls 24b). Additionally, the permanent magnet 27-1 and the permanent magnet 27-2 are arranged parallel to each other with a predetermined distance therebetween in the optical axis direction with the magnet support projection 21b, which projects radially outwards through the slot 24c, sandwiched (inserted) between the side surface 27e of the permanent magnet 27-1 and the side surface 27d of the permanent magnet 27-2. The magnet support projection 21b is smaller in length than the permanent magnet 27-1 and the permanent magnet 27-2 in the circumferential direction, and an adhesive injection space M1 is formed between the side surface 27e of the permanent magnet 27-1 and the side surface 27d of the permanent magnet 27-2 by the magnet support projection 21b being sandwiched between central portions of the permanent magnet 27-1 and the permanent magnet 27-2 in the longitudinal direction thereof (see FIGS. 18 and 21). In the above illustrated supported state of the permanent magnet unit 27 by the yoke 24 and the magnet support projection 21b, the side surface 27d of the permanent magnet 27-1 lies at substantially the same position as the front end surface of the barrel holder 12 (the front edge of the yoke 24) with respect to the optical axis direction, and the side surface 27e of the permanent magnet 27-2 lies at substantially the same position as the rear end surface of the barrel holder 12 (the rear edge of the yoke 24) with respect to the optical axis direction (see FIGS. 18 and 21). Accordingly, the sum of the widths of the permanent magnet 27-1, the magnet support projection 21b and the permanent magnet 27-2 in the optical axis direction substantially corresponds to (is substantially equal to) the length of each of the barrel holder 12 and the yoke 24 in the optical axis direction, so that the first magnet unit 27 is supported by the barrel holder 12 without jutting out either forwardly or rearwardly from the barrel holder 12.

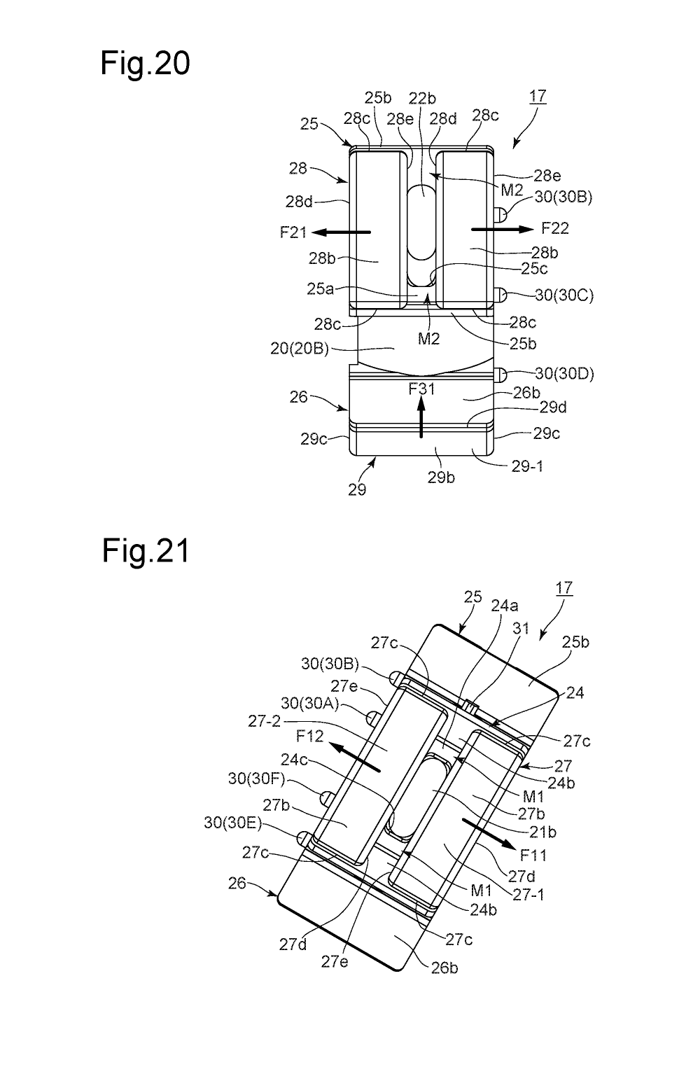

The second magnet unit 28 is mounted on the yoke 25 so that the permanent magnet 28-1 and the permanent magnet 28-2 are parallel-positioned side by side, with respect to the optical axis direction (the short-side direction of the permanent magnet 28-1 and the permanent magnet 28-2) on the front and rear of the yoke 25, respectively. As shown in FIGS. 8, 9, 16 through 18 and 20, the inner peripheral surfaces 28a of the permanent magnet 28-1 and the permanent magnet 28-2 are mounted on the base wall 25a with the pair of longitudinal end surfaces 28c facing the pair of standing walls 25b. Since the inner peripheral surfaces 28a of the permanent magnet 28-1 and the permanent magnet 28-2 are curved surfaces along the base wall 25a, the permanent magnet 28-1 and the permanent magnet 28-2 are stably supported radially by engagement between the base wall 25a and the inner peripheral surfaces 28a. In addition, the positions of the permanent magnet 28-1 and the permanent magnet 28-2 in the circumferential direction are determined by the pair of standing walls 25b holding the permanent magnet 28-1 and the permanent magnet 28-2 from either side with respect to the circumferential direction (i.e., by the engagement of the pair of longitudinal end surfaces 28c with the pair of standing walls 25b). Additionally, the permanent magnet 28-1 and the permanent magnet 28-2 are arranged parallel to each other with a predetermined distance therebetween in the optical axis direction with the magnet support projection 22b that projects radially outwards through the slot 25c sandwiched (inserted) between the side surface 28e of the permanent magnet 28-1 and the side surface 28d of the permanent magnet 28-2. The magnet support projection 22b is smaller in length than the permanent magnet 28-1 and the permanent magnet 28-2 in the circumferential direction, and an adhesive injection space M2 is formed between the side surface 28e of the permanent magnet 28-1 and the side surface 28d of the permanent magnet 28-2 by the magnet support projection 22b being sandwiched between central portions of the permanent magnet 28-1 and the permanent magnet 28-2 in the longitudinal direction thereof (see FIGS. 18 and 20). In the above illustrated supported state of the permanent magnet unit 28 by the yoke 25 and the magnet support projection 22b, the side surface 28d of the permanent magnet 28-1 lies at substantially the same position as the front end surface of the barrel holder 12 (the front edge of the yoke 25) with respect to the optical axis direction, and the side surface 28e of the permanent magnet 28-2 lies at substantially the same position as the rear end surface of the barrel holder 12 (the rear edge of the yoke 25) with respect to the optical axis direction (see FIGS. 8, 18 and 20). Accordingly, the sum of the widths of the permanent magnet 28-1, the magnet support projection 22b and the permanent magnet 28-2 in the optical axis direction substantially corresponds to (is substantially equal to) the length of each of the barrel holder 12 and the yoke 25 in the optical axis direction, so that the second magnet unit 28 is supported by the barrel holder 12 without jutting out either forwardly or rearwardly from the barrel holder 12.

As shown in FIGS. 6, 9 through 17, 19 and 20, the imaging apparatus 10 is provided with a third magnet unit (driver) 29 which is supported on the yoke 26. The third magnet unit 29 is configured of a set (pair) of circular-arc shaped permanent magnets 29-1 and 29-2 which are elongated in the optical axis direction. The permanent magnets 29-1 and 29-2 are identical in shape and size and are each provided with an inner peripheral surface 29a and an outer peripheral surface 29b. The inner peripheral surface 29a is a portion of an imaginary cylindrical surface which is centered on the optical axis O, while the outer peripheral surface 29b is a portion of an imaginary cylindrical surface which is centered on the optical axis O and is concentric with and greater in diameter than the imaginary cylindrical surface which includes the inner peripheral surface 29a. In addition, each of the permanent magnets 29-1 and 29-2 is provided with a pair of longitudinal end surfaces 29c which are positioned at either end with respect to the longitudinal direction of the permanent magnet (i.e., in the optical axis direction) and radially connect the inner peripheral surface 29a with the outer peripheral surface 29b, and a pair of side surfaces 29d and 29e which extend between the pair of longitudinal end surfaces 29c in the longitudinal direction of the permanent magnet (i.e., in the optical axis direction) and radially connect the inner peripheral surface 29a with the outer peripheral surface 29b.

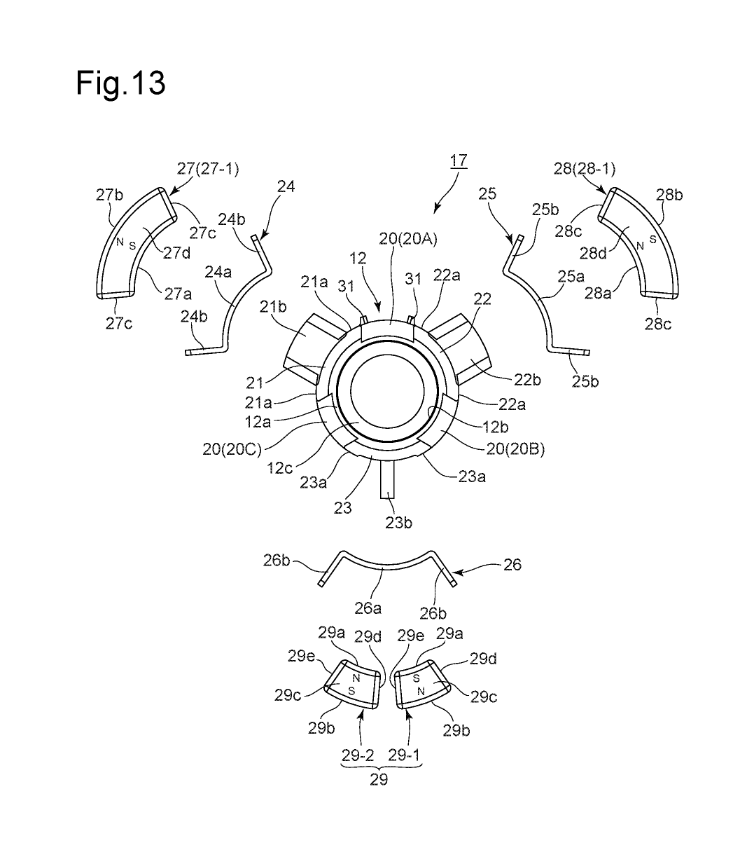

Unlike the first magnet unit 27 and the second magnet unit 28, the third magnet unit 29 is mounted on the yoke 26 so that the permanent magnet 29-1 and the permanent magnet 29-2 are parallel-positioned side by side with respect to the circumferential direction (the short-side direction of the permanent magnet 29-1 and the permanent magnet 29-2), respectively. As shown in FIGS. 7, 9, 16, 17 and 19, the inner peripheral surfaces 29a of the permanent magnet 29-1 and the permanent magnet 29-2 are mounted on the base wall 26a with the side surface 29d of the permanent magnet 29-1 facing one of the pair of standing walls 26b (the right standing wall 26b with respect to FIG. 13) and with the side surface 29e of the permanent magnet 29-2 facing the other standing wall 26b (the left standing wall 26b with respect to FIG. 13). Since the inner peripheral surfaces 29a of the permanent magnet 29-1 and the permanent magnet 29-2 are curved surfaces along the base wall 26a, the permanent magnet 29-1 and the permanent magnet 29-2 are stably supported radially by engagement between the base wall 26a and the inner peripheral surfaces 29a. The permanent magnet 29-1 and the permanent magnet 29-2 are arranged parallel to each other with a predetermined distance therebetween in the circumferential direction with the magnet support projection 23b that projects radially outwards through the slot 26c sandwiched between the side surface 29e of the permanent magnet 29-1 and the side surface 29d of the permanent magnet 29-2. The magnet support projection 23b is smaller in length than the permanent magnet 29-1 and the permanent magnet 29-2 in the optical axis direction, and an adhesive injection space M3 is formed between the side surface 29e of the permanent magnet 29-1 and the side surface 29d of the permanent magnet 29-2 by the magnet support projection 23b being sandwiched between central portions of the permanent magnet 29-1 and the permanent magnet 29-2 in the longitudinal direction thereof (see FIG. 19). The position of the third magnet unit 29 in the circumferential direction is determined by the pair of standing walls 26b holding the permanent magnet 29-1 and the permanent magnet 29-2 from either side in the circumferential direction with the magnet support projection 23b sandwiched between the permanent magnet 29-1 and the permanent magnet 29-2. In other words, the sum of the widths of the permanent magnet 29-1, the magnet support projection 23b and the permanent magnet 29-2 in the circumferential direction substantially corresponds to (is substantially equal to) the distance between the pair of standing walls 26b in the circumferential direction. In addition, the length of each permanent magnet 29-1 and 29-2 (the distance between the pair of longitudinal end surfaces 29c of each permanent magnet 29-1 and 29-2) in the optical axis direction substantially corresponds to (is substantially equal to) the length of each of the barrel holder 12 and the yoke 26 in the optical axis direction. Additionally, the front longitudinal end surface 29c of the permanent magnet 29-1 and the front longitudinal end surface 29c of the permanent magnet 29-2 lie at the substantially the same position as the front end surface of the barrel holder 12 (the front edge of the yoke 26) with respect to the optical axis direction, and the rear longitudinal end surface 29c of the permanent magnet 29-1 and the rear longitudinal end surface 29c lie at the substantially the same position as the rear end surface of the barrel holder 12 (the rear edge of the yoke 26) with respect to the optical axis direction, so that the third magnet unit 29 is supported by the barrel holder 12 without jutting out either forwardly or rearwardly from the barrel holder 12 (see FIG. 19).

Adhesive is injected into each of the first, second and third adhesive injection spaces M1, M2 and M3. The yoke 24 and the first magnet unit 27 are fixed to the barrel holder 12 (the magnet support projection 21b) by the adhesive injected into the first adhesive injection space M1. The yoke 25 and the second magnet unit 28 are fixed to the barrel holder 12 (the magnet support projection 22b) by the adhesive injected into the second adhesive injection space M2. The yoke 26 and the third magnet unit 29 are fixed to the barrel holder 12 (the magnet support projection 23b) by the adhesive injected into the third adhesive injection space M3. Accordingly, an adhesive-fixing portion at which each permanent magnet 27-1 and 27-2 of the first magnet unit 27 is fixed to the magnet support projection 21b and the yoke 24 with an adhesive is formed in the adhesive injection space M1, an adhesive-fixing portion at which each permanent magnet 28-1 and 28-2 of the second magnet unit 28 is fixed to the magnet support projection 22b and the yoke 25 with an adhesive is formed in the adhesive injection space M2, and an adhesive-fixing portion at which each permanent magnet 29-1 and 29-2 of the third magnet unit 29 is fixed to the magnet support projection 23b and the yoke 26 with an adhesive is formed in the adhesive injection space M3.

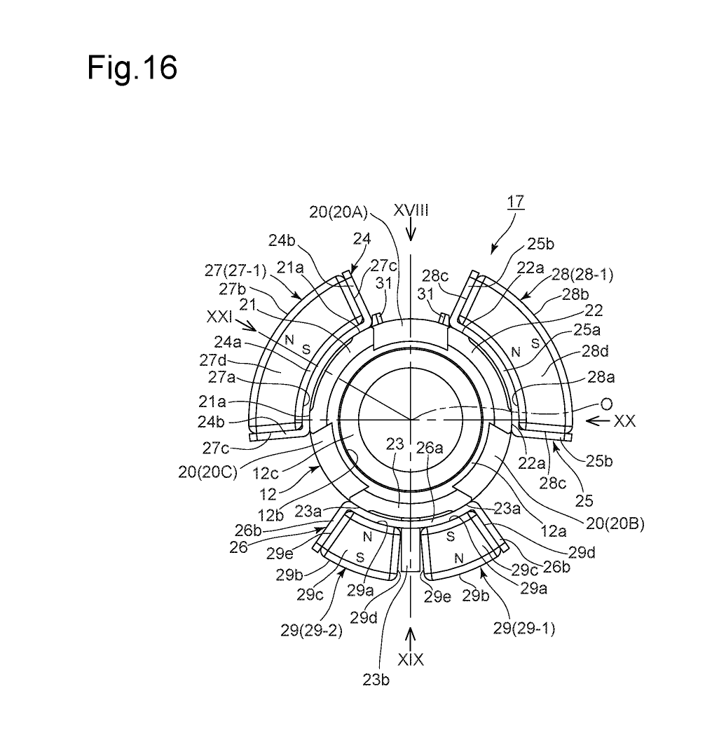

The movable unit 17, which is the subassembly that is shown in FIGS. 16 through 21, is completed (assembled) by mounting the yokes 24, 25 and 26 and the first, second and third magnet units 27, 28 and 29 to the barrel holder 12 as described above. In the movable unit 17, a combination of the yoke 24 and the first magnet unit 27 (including the magnet support projection 21b), a combination of the yoke 25 and the second magnet unit 28 (including the magnet support projection 22b) and a combination of the yoke 26 and the third magnet unit 29 (including the magnet support projection 23b) are substantially identical in size in the circumferential direction and the optical axis direction, and are arranged at substantially equi-angular intervals (intervals of 120 degrees) in the circumferential direction.

As shown in FIGS. 6, 9, 16 and 17, the outer peripheral surfaces 27b, 28b and 29b of the first, second and third magnet units 27, 28 and 29 of the movable unit 17 lie on an imaginary cylindrical surface which is centered on the optical axis O, and the inner peripheral surfaces 27a, 28a and 29a of the first, second and third magnet units 27, 28 and 29 lie on a different imaginary cylindrical surface which is centered on the optical axis O and smaller in diameter than the imaginary cylindrical surface on which the outer peripheral surfaces 27b, 28b and 29b lie.

The north and south poles of each permanent magnet 27-1, 27-2, 28-1, 28-2, 29-1 and 29-2 of the first magnet unit 27, the second magnet unit 28 and the third magnet unit 29 in the movable unit 17 are designated conceptually by the reference characters “N” and “S”, respectively, in FIGS. 13 and 15 through 17. Each permanent magnet 27-1, 27-2, 28-1, 28-2, 29-1 and 29-2 is magnetized so that the north pole and the south pole are radially aligned. In addition, each permanent magnet 27-1, 28-2 and 29-1 is set so that the south and north poles thereof are positioned on the radially inner side and the radially outer side, respectively, while each permanent magnet 27-2, 28-1 and 29-2 is set so that the north and south poles thereof are positioned on the radially inner side and the radially outer side, respectively. The above described structure in which each of the first, second and third magnet units 27, 28 and 29 is split into two (two permanent magnets which are parallel-arranged in the short-side direction thereof) facilitates magnetization of the magnets and is also advantageous for the reduction in weight.

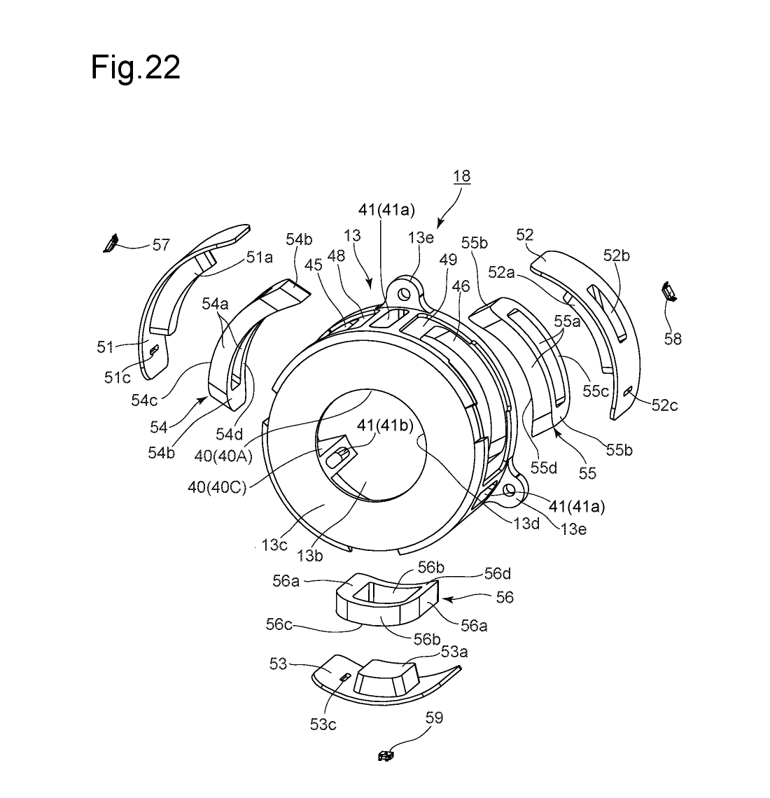

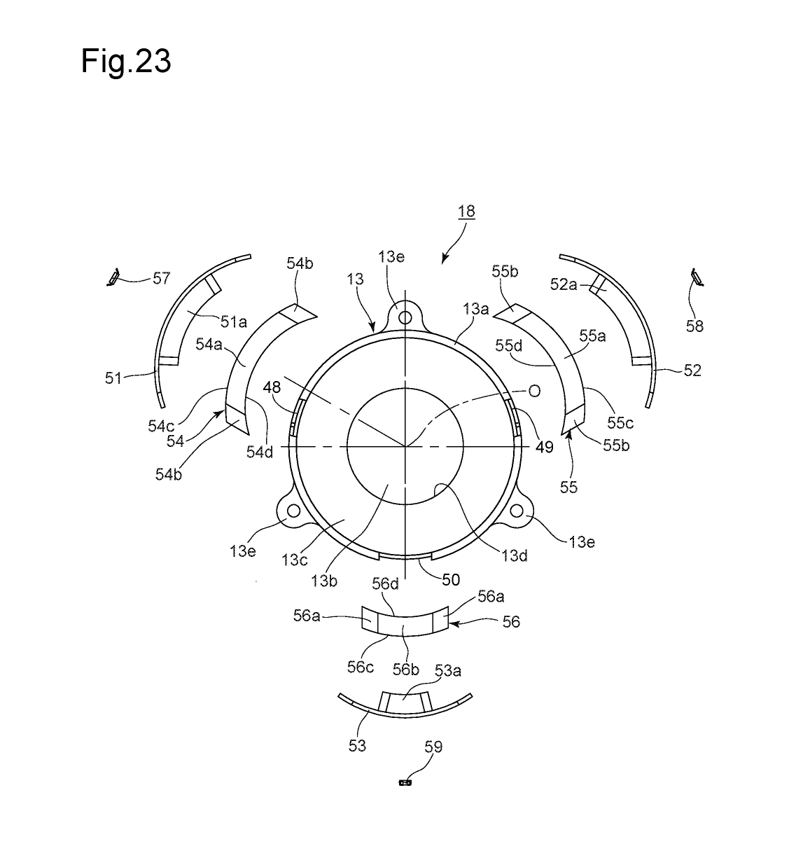

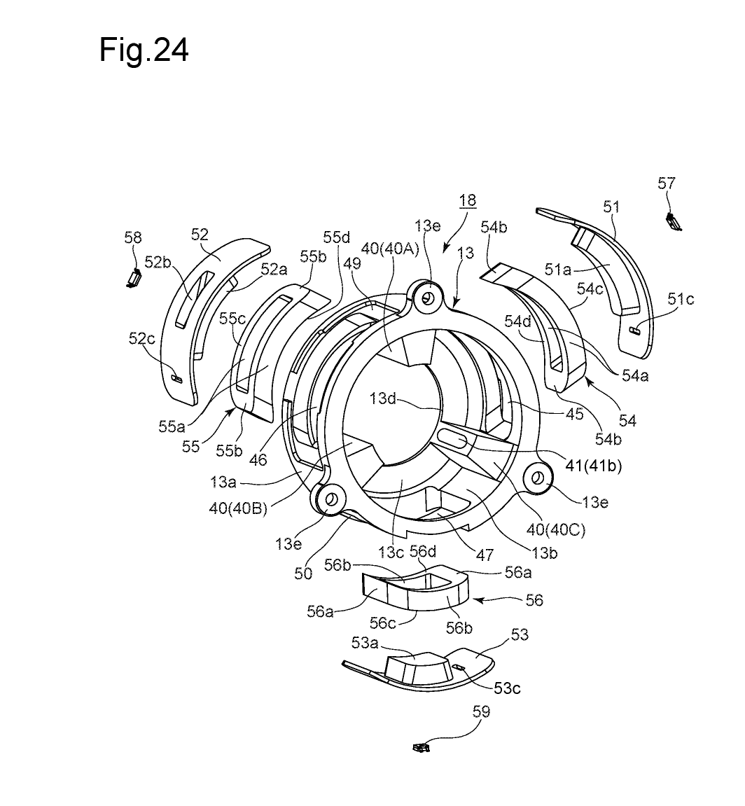

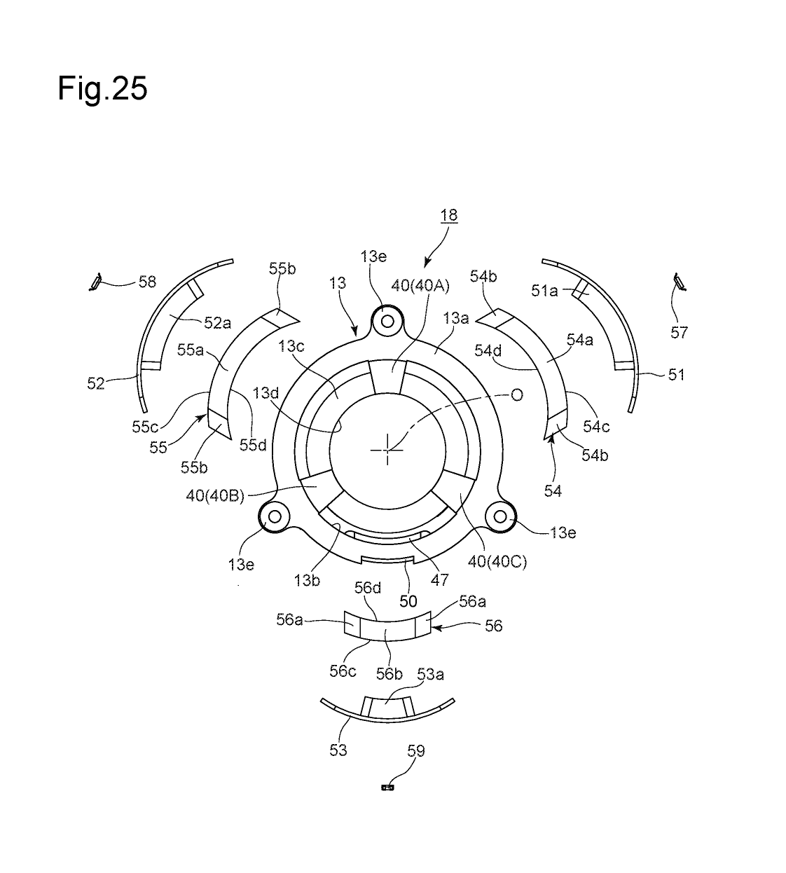

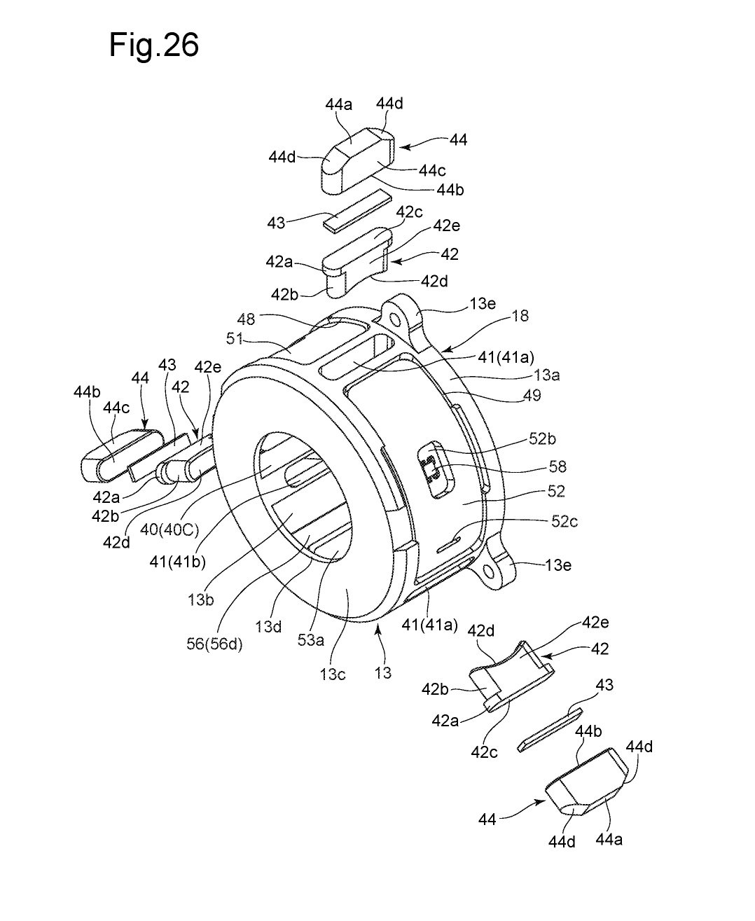

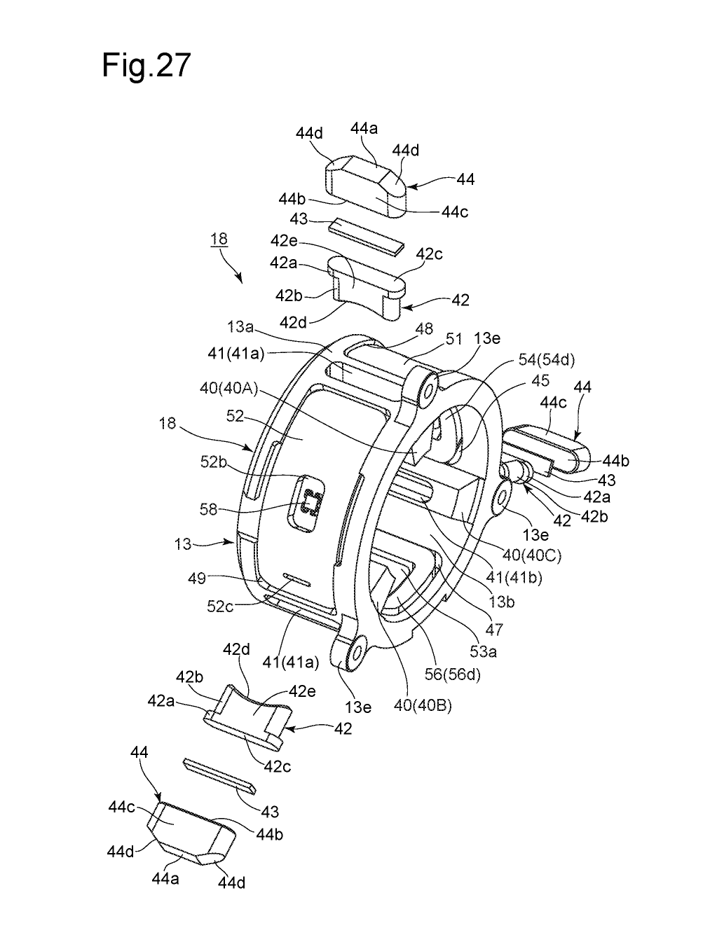

As shown in FIGS. 7, 8, 10, 11 and 22 through 27, the coil holder 13 is provided, inside a cylindrical portion 13a thereof that surrounds the optical axis O, with an axial through-portion 13b which extends through the coil holder 13 in the optical axis direction. The coil holder 13 is provided at the front end thereof with a front wall 13c which projects radially inwards so that the radially inner edge of the front wall 13c forms a circular central aperture 13d. The central aperture 13d is smaller in diameter than the axial through-portion 13b. The coil holder 13 is provided, at the rear end of the cylindrical portion 13a at substantially equi-angular intervals (intervals of 120 degrees) in the circumferential direction, with three mounting projections 13e which project radially outwards. A screw insertion hole is formed in each mounting projection 13e to extend therethrough in the optical axis direction. Three set screws (not shown) can be screw-engaged in the screw insertion holes of the three mounting projections 13e when the imaging apparatus 10 is mounted to an electronic apparatus or the like.

As shown in FIGS. 6 through 11, 22 and 24 through 27, the coil holder 13 is provided with three thick-walled portions 40 which project radially inwards from the inner peripheral surface of the cylindrical portion 13a. The three thick-walled portions 40 are provided at substantially equi-angular intervals (intervals of 120 degrees) in the circumferential direction and are designated by the reference characters 40A, 40B and 40C. Each thick-walled portion 40 (40A, 40B and 40C) is in the shape of a wedge in cross section whose width in the circumferential direction narrows with respect to the inward radial direction, and a through-hole 41 is formed in each thick-walled portion 40 to radially extend therethrough. Each through-hole 41 is a slot whose length in the optical axis direction is greater than the width in the circumferential direction. Each through-hole 41 has a radially outer side hole 41a and a radially inner side hole 41b, and the radially outer side hole 41a is greater in length in the optical axis direction than the radially inner side hole 41b (see FIGS. 7 and 8). In addition, the radially outer side hole 41a is slightly greater in width in the circumferential direction than the radially inner side hole 41b (see FIG. 9). Each thick-walled portion 40 is further provided, in the through-hole 41 thereof at a position in the radial direction between the radially outer side hole 41a and the radially inner side hole 41b, with a flange fitting portion 41c (see FIGS. 7 and 8). The flange fitting portion 41c, which is formed in each through-hole 41, is substantially identical in width in the circumferential direction to the radially inner side hole 41b, greater in length in the optical axis direction than the radially inner side hole 41b and slightly smaller in length in the optical axis direction than the radially outer side hole 41a. A restricting surface (restrictor) 41d which faces radially outwards is formed at the base of the flange fitting portion 41c in the through-hole 41 of each thick-walled portion 40 (see FIGS. 7 and 8).

As shown in FIGS. 7 through 9, 22, 24 and 25, the cylindrical portion 13a of the coil holder 13 is provided with three through-holes 45, 46 and 47 which are formed radially through the cylindrical portion 13a. The three through-holes 45, 46 and 47 are formed at positions between the three thick-walled portions 40 in the circumferential direction. Specifically, the through-hole 45 is formed between the thick-walled portions 40A and 40C in the circumferential direction, the through-hole 46 is formed between the thick-walled portions 40A and 40B in the circumferential direction, and the through-hole 47 is formed between the thick-walled portions 40B and 40C in the circumferential direction. Each of the two through-holes 45 and 46 is a hole elongated in the circumferential direction and has a substantially rectangular shape in a development view when the cylindrical portion 13a is developed on a flat surface. The through-hole 45 and the through-hole 46 are substantially identical in length in the circumferential direction and also in width in the optical axis direction. The through-hole 47 also has a substantially rectangular shape in a development view when the cylindrical portion 13a is developed on a flat surface, however the through-hole 47 is different in ratio between the length in the circumferential direction and the width in the optical axis direction compared to the through-holes 45 and 46. Specifically, the through-hole 47 is smaller in length in the circumferential direction than the through-holes 45 and 46 and greater in length in the optical axis direction than the through-holes 45 and 46. When the centers of the through-holes 45, 46 and 47 in the circumferential direction are referred to as reference positions of the through-holes 45, 46 and 47 in the circumferential direction, these reference positions are positioned at substantially equi-angular intervals (intervals of 120 degrees) in the circumferential direction.

As shown in FIGS. 8 through 11 and 22 through 27, the coil holder 13 is provided, around the three through-holes 45, 46 and 47 on the outer peripheral surface of the cylindrical portion 13a, with three support recesses (hollow bottomed portions) 48, 49 and 50, respectively. The support recesses 48 and 49 are recesses elongated in the circumferential direction and have a substantially identical length in the circumferential direction and have a substantially identical width in the optical axis direction. The support recess 50 is a recess smaller in length in the circumferential direction than the support recesses 48 and 49 and greater in length in the optical axis direction than the support recesses 48 and 49.

As shown in FIGS. 7 through 11 and 22 through 27, three coil support plates 51, 52 and 53 are respectively supported in the support recesses 48, 49 and 50. The coil support plates 51, 52 and 53 are plate-like members which extend along the outer peripheral surface of the cylindrical portion 13a. The outer surfaces of the coil support plates 51, 52 and 53 are substantially flush with the outer peripheral surface of the cylindrical portion 13a when fitted into the support recesses 48, 49 and 50. Namely, the coil support plates 51, 52 and 53 lie on an imaginary cylindrical surface centered on the optical axis O. The coil support plates 51 and 52 are substantially identical in shape and size. The coil support plate 51 is provided, in the vicinity of the center thereof with respect to both the circumferential direction and the optical axis direction, with a coil support projection 51a which projects radially inwards, and the coil support plate 52 is provided, in the vicinity of the center thereof in both the circumferential direction and the optical axis direction, with a coil support projection 52a which projects radially inwards. A sensor support recess (bottomed hole) 51b and a sensor support recess (bottomed hole) 52b are formed in the coil support projection 51a and the coil support projection 52a, respectively. Each sensor support recess 51b and 52b is open radially outwards. The coil support plate 53 is smaller in length in the circumferential direction than the coil support plates 51 and 52 and greater in width in the optical axis direction than the coil support plates 51 and 52. The coil support plate 53 is provided, in the vicinity of the center thereof with respect to both the circumferential direction and the optical axis direction, with a coil support projection 53a which projects radially inwards, and a sensor support recess (bottomed hole) 53b is formed in the coil support projection 53a. The sensor support recess 53b is open radially outwards. The coil support plates 51, 52 and 53 are further provided with three through-holes 51c, 52c and 53c which extend radially therethrough, respectively.

The first coil (driver) 54, the second coil (driver) 55 and the third coil (driver) 56 are supported by the first support plate 51, the second support plate 52 and the third support plate 53, respectively. The first coil 54 is an air-core coil which includes a pair of long-side portions (circumferentially-extending portions) 54a and a pair of short-side portions (axially-extending portions) 54b. The pair of long-side portions 54a are greater in length than the pair of short-side portions 54b. The pair of long-side portions 54a are spaced from each other in the optical axis direction and are elongated in the circumferential direction, and the pair of short-side portions 54b which are elongated in the optical axis direction connect the pair of long-side portions 54a at the respective ends thereof. Likewise, the second coil 55 is an air-core coil which includes a pair of long-side portions (circumferentially-extending portions) 55a and a pair of short-side portions (axially-extending portions) 55b. The pair of long-side portions 55a are greater in length than the pair of short-side portions 55b. The pair of long-side portions 55a are spaced from each other in the optical axis direction and are elongated in the circumferential direction, and the pair of short-side portions 55b which are elongated in the optical axis direction connect the pair of long-side portions 55a at the respective ends thereof. The third coil 56 is an air-core coil which includes a pair of long-side portions 56a and a pair of short-side portions 56b. The pair of long-side portions 56a are spaced from each other in the circumferential direction and are elongated in the optical axis direction, and the pair of short-side portions 56b which are elongated in the circumferential direction connect the pair of long-side portions 56a at the respective ends thereof.

The first coil 54 and the second coil 55 are substantially identical in shape and size. The pair of long-side portions 54a and the pair of long-side portions 55a are substantially identical in length in the circumferential direction, and the pair of short-side portions 54b and the pair of short-side portions 55b are substantially identical in length in the optical axis direction. The pair of long-side portions 56a of the third coil 56 are greater in length in the optical axis direction than the pair of short-side portions 54b and the pair of short-side portions 55b, and the pair of short-side portions 56b of the third coil 56 are smaller in length in the circumferential direction than the pair of long-side portions 54a and the pair of long-side portions 55a.

The first coil 54 is provided with a curved outer peripheral surface 54c and a curved inner peripheral surface 54d, the second coil 55 is provided with a curved outer peripheral surface 55c and a curved inner peripheral surface 55d, and the third coil 56 is provided with a curved outer peripheral surface 56c and a curved inner peripheral surface 56d. Each of the outer peripheral surfaces 54c, 55c and 56c is a portion of an imaginary cylindrical surface which is centered on the optical axis O and includes the inner peripheral surfaces of the coil support plates 51, 52 and 53 (i.e., in which the inner peripheral surfaces of the coil support plates 51, 52 and 53 lie), while each of the inner peripheral surfaces 54d, 55d and 56d lies in a different imaginary cylindrical surface which is centered on the optical axis O and smaller in diameter than the aforementioned imaginary cylindrical surface which includes the outer peripheral surfaces 54c, 55c and 56c.

The first coil 54 has a hollow portion surrounded by the pair of long-side portions 54a and the pair of short-side portions 54b and is mounted to the coil support plate 51 by inserting the coil support projection 51a into the hollow portion of the first coil 54 and bringing the outer peripheral surface 54c into contact with the inner peripheral surface of the coil support plate 51. The coil support plate 51 and the first coil 54 are fixed to each other with an adhesive or the like. With the first coil 54 fixed to the coil support plate 51 in this manner, fitting the coil support plate 51 into the support recess 48 to be supported on the cylindrical portion 13a of the coil holder 13 causes the first coil 54 to be inserted into the through-hole 45, thus causing the inner peripheral surface 54d of the first coil 54 to face toward the radially inner side of the coil holder 13 (see FIGS. 6, 9 and 27).

The second coil 55 has a hollow portion surrounded by the pair of long-side portions 55a and the pair of short-side portions 55b and is mounted to the coil support plate 52 by inserting the coil support projection 52a into the hollow portion of the second coil 55 and bringing the outer peripheral surface 55c into contact with the inner peripheral surface of the coil support plate 52. The coil support plate 52 and the second coil 55 are fixed to each other with an adhesive or the like. With the second coil 55 fixed to the coil support plate 52 in this manner, fitting the coil support plate 52 into the support recess 49 to be supported on the cylindrical portion 13a of the coil holder 13 causes the second coil 55 to be inserted into the through-hole 46, thus causing the inner peripheral surface 55d of the second coil 55 to face toward the radially inner side of the coil holder 13 (see FIGS. 6, 8 and 9).

The third coil 56 has a hollow portion surrounded by the pair of long-side portions 56a and the pair of short-side portions 56b and is mounted to the coil support plate 53 by inserting the coil support projection 53a into the hollow portion of the third coil 56 and bringing the outer peripheral surface 56c into contact with the inner peripheral surface of the coil support plate 53. The coil support plate 53 and the third coil 56 are fixed to each other with an adhesive or the like. With the third coil 56 fixed to the coil support plate 53 in this manner, fitting the coil support plate 53 into the support recess 50 to be supported on the cylindrical portion 13a of the coil holder 13 causes the third coil 56 to be inserted into the through-hole 47, thus causing the inner peripheral surface 56d of the third coil 56 to face toward the radially inner side of the coil holder 13 (see FIGS. 6, 7, 9 and 27).

FIG. 9 shows the positional relationship between the first coil 54, the second coil 55 and the third coil 56 which are mounted to the coil holder 13 via the coil support plates 51, 52 and 53. As can be seen from FIG. 9, the first coil 54, the second coil 55 and the third coil 56 are positioned so that the outer peripheral surfaces 54c, 55c and 56c lie on an imaginary cylindrical surface which is centered on the optical axis O, and so that the inner peripheral surfaces 54d, 55d and 56d lie on a different imaginary cylindrical surface which is centered on the optical axis O and smaller in diameter than the aforementioned imaginary cylindrical surface which includes the outer peripheral surfaces 54c, 55c and 56c.

As shown in FIGS. 7 through 11 and 22 through 27, a Hall sensor (magnetic sensor) 57 is provided inside the sensor support recess 51b of the coil support plate 51, a Hall sensor (magnetic sensor) 58 is provided inside the sensor support recess 52b of the coil support plate 52, and a Hall sensor (magnetic sensor) 59 is provided inside the sensor support recess 53b of the coil support plate 53. The Hall sensors 57, 58 and 59 are fixed to the bases of the sensor support recesses 51b, 52b and 53b, respectively. The sensor support recesses 51b, 52b and 53b are recesses which are open radially outwards and recessed using the internal spaces of the coil support projections 51a, 52a and 53a that project radially inwards. Accordingly, the Hall sensors 57, 58 and 59, which are installed inside the sensor support recesses 51b, 52b and 53b, are supported in a state of being housed in the hollow spaces of the coils 54, 55 and 56, respectively (see FIGS. 7 through 9). As shown in FIG. 9, the Hall sensors 57, 58 and 59 in this supported state are positioned at substantially equi-angular intervals (intervals of 120 degrees) in the circumferential direction and lie on an imaginary cylindrical surface which is centered on the optical axis O (the radial distances of the Hall sensors 57, 58 and 59 from the optical axis O are substantially the same). In addition, each Hall sensor 57, 58 and 59 lies on the imaginary plane P1.

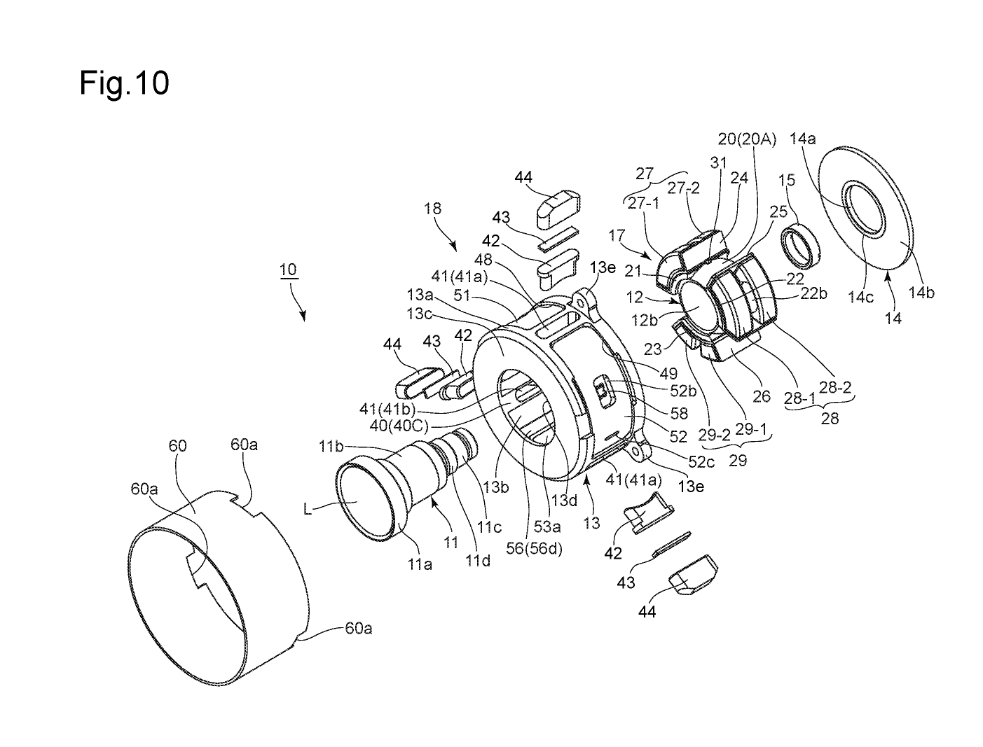

Mounting the first coil 54, the second coil 55 and the third coil 56 and the three Hall sensors 57, 58 and 59 to the coil holder 13 via the three coil support plates 51, 52 and 53 as described above completes the stationary unit 18 that is configured as a subassembly shown in FIGS. 10, 11, 28 and 27.

The movable unit 17 is supported to be capable of rotating in any rotational direction about the spherical-swinging center Q (capable of performing a spherical-swinging operation) relative to the stationary unit 18. As shown in FIGS. 7 through 11, 26 and 27, the imaging apparatus 10 is provided, inside the through-hole 41 of each thick-walled portion 40A, 40B and 40C of the coil holder 13, with a support member (supporter) 42, a resilient member (supporter/shock absorber) 43 and a retainer member (retainer/supporter) 44, in that order from the radially inner side, as elements of a support structure which supports the movable unit 17 in a manner to allow the barrel holder 12 to spherically swing.

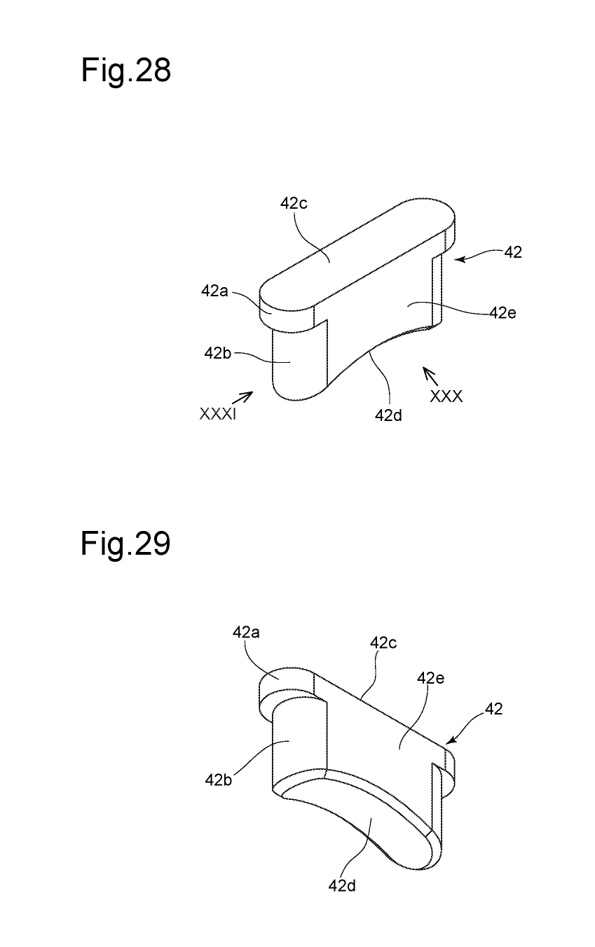

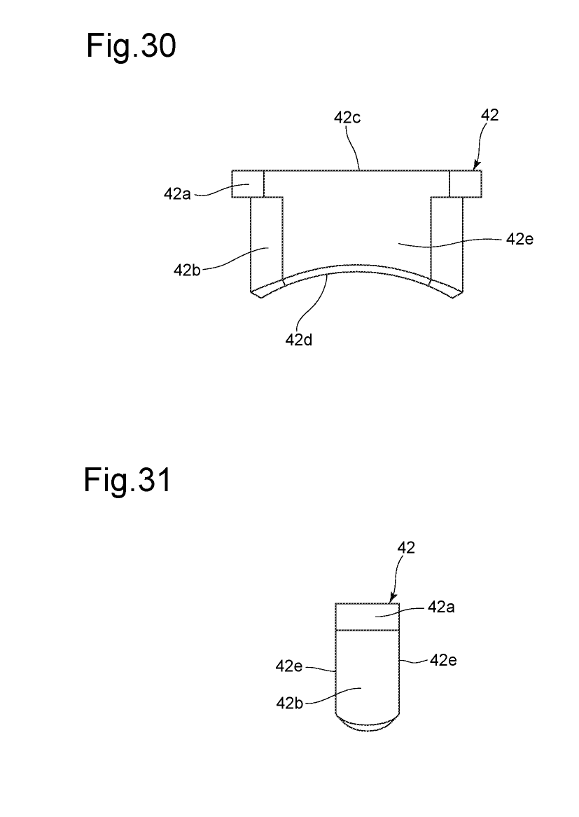

As shown in FIGS. 28 through 35, each of the three support members 42 that are respectively fitted into the three through-holes 41 is provided with a flange (restrictor) 42a which is positioned on the radially outer side of the support member 42 and a projecting portion 42b which projects radially inwards from the flange 42a. In addition, a flat holding surface 42c is formed at the radially outer end of the flange 42a, and a support surface (supporter) 42d is formed at the radially inner end of the projecting portion 42b. The support surface 42d is a concave cylindrical surface and will be discussed in detail later. Each support member 42 is provided on either side thereof in the circumferential direction with a pair of side surfaces 42e which are substantially parallel to each other and are formed to be continuous with the flange 42a and the projecting portion 42b. Both ends of the flange 42a with respect to the optical axis direction are formed as curved surfaces and both ends of the projecting portion 42b with respect to the optical axis direction are formed as curved surfaces. The length of the projecting portion 42b in the optical axis direction and the width of the projecting portion 42b in the circumferential direction correspond to (are substantially equal to) those of the radially inner side hole 41b of the associated through-hole 41. The flange 42a is greater in length in the optical axis direction than the projecting portion 42b. The length of the flange 42a in the optical axis direction and the width of the flange 42a in the circumferential direction correspond to (are substantially equal to) those of the flange fitting portion 41c of the associated through-hole 41. Accordingly, the flange 42a of each support member 42 can be inserted into each through-hole 41 up to the flange fitting portion 41c through the radially outer side hole 41a, and has a size and shape that prevents the flange 42a from being inserted into the radially inner side hole 41b due to the restricting surface 41d.

As shown in FIGS. 7 and 8, each support member 42 is inserted into the associated through-hole 41 from the radially outer end opening of the radially outer side hole 41a with the support surface 42d facing radially inwards, and is prevented from further moving radially inwards (from being further inserted into the associated through-hole 41) by engagement of the flange 42a with the restricting surface 41d. In this state, a radially inner part of the projecting portion 42b of each support member 42 which includes the support surface 42d projects radially inwards from the radially inner end of the associated thick-walled portion 40A, 40B or 40C through the radially inner side hole 41b of the associated through-hole 41 (see FIGS. 6 through 9). In this inserted state of each support member 42 into the associated through-hole 41, the position of each support member 42 in the circumferential direction is determined by engagement of the pair of side surfaces 42e with inner surfaces of the associated through-hole 41 (inner surfaces of the radially inner side hole 41b and the flange fitting portion 41c), while the position of each support member 42 in the optical axis direction is determined by engagement of the front and rear curved surfaces of the support member 42, which connect the pair of side surfaces 42e, with inner surfaces of the associated through-hole 41 (inner surfaces of the radially inner side hole 41b and the flange fitting portion 41c). Accordingly, each support member 42 comes into a state of being allowed to move relative to the associated through-hole 41 only in the outward radial direction and thus prevented from moving in any other direction.

Each resilient member 43 is a substantially rectangular plate-like member made of a resiliently deformable material and having dimensions (a length in the optical axis direction and a width in the circumferential direction) which fall within the dimensions of the radially outer side hole 41a of each through-hole 41. Each resilient member 43 is supported on the holding surface 42c of the associated support member 42 in the associated through-hole 41.

Each retainer member 44 is provided with a pressed surface 44a which faces radially outwards, a holding surface 44b which faces radially inwards, a pair of side surfaces 44c which are substantially parallel to each other, and a pair of tapered (inclined) surfaces (guide surfaces) 44d which are positioned immediately in front of and behind the pressed surface 44a. The pressed surface 44a and the holding surface 44b of each retainer member 44 are flat surfaces substantially parallel to each other. Both ends of each retainer member 44 in the optical axis direction are formed as curved surfaces which connect the pair of side surfaces 44c. Each tapered surface 44d is an inclined surface which is inclined toward the radially inner side from the radially outer side in a direction to approach the end (curved end) of the retainer member 44 (to approach the associated curved surface) in the optical axis direction away from the pressed surface 44a. The length of the retainer member 44 in the optical axis direction and the width of the retainer member 44 in the circumferential direction correspond to those of the radially outer side hole 41a of the associated through-hole 41. The position of each retainer member 44 with respect to the circumferential direction is determined by engagement of the pair of side surfaces 44c with inner surfaces of the associated through-hole 41 (inner surfaces of the radially outer side hole 41a), while the position of each retainer member 44 with respect to the optical axis direction is determined by engagement of the front and rear curved surfaces of the retainer member 44, which connect the pair of side surfaces 44c, with inner surfaces of the associated through-hole 41 (inner surfaces of the radially outer side hole 41a). In addition, radially inward movement (insertion) of each retainer member 44 is restricted by engagement of the holding surface 44b with the associated resilient member 43. In this state, a radially outer part of each retainer member 44 which includes the pressed surface 44a and the pair of tapered surfaces 44d slightly projects radially outwards from the radially outer end opening of the radially outer side hole 41a of the associated through-hole 41 (from the outer peripheral surface of the cylindrical portion 13a).

In regard to a procedure for installing the three resilient members 43 and the three retainer members 44, one resilient member 43 and one retainer member 44 can be inserted into each through-hole 41 in that order after one support member 42 is inserted into this through-hole 41, or one support member 42, one resilient member 43 and one retainer member 44 can be collectively inserted into each through-hole 41. In either case, the three support members 42, the three resilient members 43 and the three retainer members 44 are inserted into the three through-holes 41 in the inward radial direction from the radially outer end openings of the radially outer side holes 41a of the three through-holes 41.

As described above, inserting one support member 42, one resilient member 43 and one retainer member 44 into one through-hole 41 causes the flange 42a of the support member 42 to come into contact with the restricting surface 41d, to thereby determine the position of the support member 42 in the radial direction, so that the resilient member 43 is sandwiched between the holding surface 42c of the support member 42 and the holding surface 44b of the retainer member 44. In a state where the radially outer end opening of each through-hole 41 is not closed, each retainer member 44 which is supported on the associated resilient member 43 in a free state projects radially outwards from the radially outer side hole 41a of the associated through-hole 41 by a predetermined amount. Each through-hole 41, each support member 42, each resilient member 43 and each retainer member 44 each have a substantially symmetrical shape with respect to the imaginary plane P1 (shown in FIGS. 7, 8 and 34), so that each support member 42, each resilient member 43 and each retainer member 44 can each be inserted into one through-hole 41 in either orientation (i.e., forward-facing or rear-facing orientation) with respect to the optical axis direction.

The imaging apparatus 10 is provided with a peripheral enveloping yoke (outer restricting portion/peripheral enveloping member) 60 which is fitted onto the outer periphery of the cylindrical portion 13a of the coil holder 13 with the three support members 42, the three resilient members 43 and the three retainer members 44 inserted into the three through-holes 41. The peripheral enveloping yoke 60 is a cylindrical member made of magnetic metallic material. The peripheral enveloping yoke 60 is greater in diameter than the cylindrical portion 13a of the coil holder 13. Upon aligning the axes of the peripheral enveloping yoke 60 and the cylindrical portion 13a of the coil holder 13 in a state before the peripheral enveloping yoke 60 is fitted onto the coil holder 13, the pairs of tapered surfaces 44d of the three retainer members 44 that project radially outwards from the three through-holes 41 intersect an extension of the peripheral enveloping yoke 60 in the optical axis direction.

The peripheral enveloping yoke 60 is provided, at the rear end thereof at substantially equi-angular intervals in the circumferential direction, with three engaging recesses 60a, in which the three mounting projections 13e of the coil holder 13 can be fitted. As shown in FIGS. 1 through 8, the coil holder 13 is inserted into the peripheral enveloping yoke 60 until the three mounting projections 13e are fully fitted into the three engaging recesses 60a and the coil holder 13 is covered by the peripheral enveloping yoke 60. Specifically, since the three mounting projections 13e are provided at the rear end of the coil holder 13, the front end of the coil holder 13 is inserted into the peripheral enveloping yoke 60 from the rear end thereof (i.e., the peripheral enveloping yoke 60 is fitted onto the coil holder 13 from the front end thereof). During this insertion operation, the rear end of the peripheral enveloping yoke 60 comes into contact with the opposed tapered surface 44d of each retainer member 44 (i.e., the front tapered surface 44d of the pair of tapered surfaces 44d of each retainer member 44 in the optical axis direction), and thereby the force in the optical axis direction which is exerted on each retainer member 44 by the peripheral enveloping yoke 60 causes a component of force which presses the retainer member 44 in the inward radial direction to be produced due to the tapered shape of the front tapered surface 44d of each retainer member 44. Each retainer member 44 which is pressed radially inwards by this component of force presses and compresses (resiliently deforms) the associated resilient member 43 via the holding surface 44b.

In the installation completion state of the peripheral enveloping yoke 60 shown in FIGS. 1 through 8, radially outward movement of each pressed member 44 is restricted by engagement of the pressed surface 44a thereof with the inner peripheral surface of the peripheral enveloping yoke 60, which keeps each resilient member 43 in a compressed and deformed state. The resiliency of each resilient member 43 in a compressed state exerts a pressing force in the inward radial direction on the associated support member 42 and exerts a pressing force in the outward radial direction on the associated retainer member 44. Since each support member 42 is prevented from moving in the direction of the pressing force in the inward radial direction and each retainer member 44 is prevented from moving in the direction of the pressing force in the outward radialr 42 and each retainer member 44 in the radial direction are thereby determined. In other words, a pressing force which presses each support member 42 radially inwards is exerted thereon by the peripheral enveloping yoke 60 and the associated retainer member 44 and resilient member 43 to thereby stabilize the position of each support member 42 in the radial direction so that the associated restricting surface 41d serves as a reference position. The position (shown in FIGS. 6 through 9 and 32 through 35) of each support member 42 in the radial direction with the flange 42a thereof brought in contact with the restricting surface 41d refers to the “support position” of each support member 42. In a state where each support member 42 is positioned at the support position, the support surface 42d of each support member 42, which is provided at the radially inner end thereof, becomes a portion of a surface of a cylinder (concave cylindrical surface) about a straight line which passes through the spherical-swinging center Q and is substantially orthogonal to the optical axis O (i.e., a straight line substantially orthogonal to the sheet of FIG. 7 or 8).

The peripheral enveloping yoke 60 mounted to the outer periphery of the cylindrical portion 13a of the coil holder 13 is stably held with no occurrence of positional deviation with respect to the cylindrical portion 13a because friction is produced between the peripheral enveloping yoke 60 and each of the three retainer members 44 that are arranged at different positions in the circumferential direction. In addition, the peripheral enveloping yoke 60 is stabilized also by magnetic attractive forces from the first, second and third magnet units 27, 28 and 29 of the movable unit 17. Additionally, the position of the peripheral enveloping yoke 60 relative to the coil holder 13 is securely determined by engagement of the three engaging recesses 60a with the three mounting projections 13e of the coil holder 13. With the peripheral enveloping yoke 60 mounted to the coil holder 13 in this manner, the central axis of the peripheral enveloping yoke 60 substantially coincides with the optical axis O. To ensure the holding of the peripheral enveloping yoke 60 with respect to the coil holder 13, the peripheral enveloping yoke 60 can be fixed to the coil holder 13 by an adhesive or the like as needed.

The reference character 28Z shown in FIG. 8 designates the range (length) of the second magnet unit 28 in the optical axis direction and the reference character 60Z shown in FIG. 8 designates the range (length) of the peripheral enveloping yoke 60 in the optical axis direction. The distance from the side surface 28d of the front permanent magnet 28-1 to the side surface 28e of the rear permanent magnet 28-2 corresponds to the range 28Z of the second magnet unit 28 in the optical axis direction. The range 60Z of the peripheral enveloping yoke 60 in the optical axis direction is greater than the range 28Z of the second magnet unit 28 in the optical axis direction, as shown in FIG. 8. Both the centers of the range 28Z of the second magnet unit 28 in the optical axis direction and the range 60Z of the peripheral enveloping yoke 60 in the optical axis direction lie on the imaginary plane P1, which passes through the spherical-swinging center Q. Namely, the center of the range 28Z, the center of the range 60Z and the spherical-swinging center Q are all located at the same position with respect to the optical axis direction. In addition, the center of the range of the second coil 55 in the optical axis direction also lies on the imaginary plane P1. Since the first magnet unit 27 is identical in shape and size to the second magnet unit 28 though not shown in FIG. 8, the first magnet unit 27 has the same positional conditions as the second magnet unit 28 with respect to the peripheral enveloping yoke 60.

The reference character 29Z shown in FIG. 7 designates the range (length) of the third magnet unit 29 in the optical axis direction. The distance between the pair of longitudinal end surfaces 29c of each permanent magnet 29-1 and 29-2 corresponds to the range 29Z of the third magnet unit 29 in the optical axis direction. The range 60Z of the peripheral enveloping yoke 60 in the optical axis direction is greater than the range 29Z of the third magnet unit 29 in the optical axis direction as shown in FIG. 7. Both the centers of the range 29Z of the third magnet unit 29 in the optical axis direction and the range 60Z of the peripheral enveloping yoke 60 in the optical axis direction lie on the imaginary plane P1, which passes through the spherical-swinging center Q. Namely, the center of the range 29Z, the center of the range 60Z and the spherical-swinging center Q are all located at the same position in the optical axis direction. Additionally, the center of the range of the third coil 56 in the optical axis direction also lies on the imaginary plane P1.

The movable unit 17 is inserted into the axial through-portion 13b of the coil holder 13 with the positions of the three swing guide surfaces 20A, 20B and 20C made coincident with the positions of the three thick-walled portions 40A, 40B and 40C with respect to the circumferential direction, respectively (i.e., with the three swing guide surfaces 20A, 20B and 20C are made to radially face the three thick-walled portions 40A, 40B and 40C, respectively). As shown in FIGS. 6 through 8, the radially innermost portions of the projecting portion 42b of each support member 42 that project radially inwards by the greatest amount (the lower left end portion and the lower right end portion of the projecting portion 42b with respect to FIG. 7) are positioned closer to the radially inner side than the radially outermost portion (with respect to a radial distance from the optical axis O) of the associated swing guide surface 20A, 20B or 20C, which project radially outwards by the greatest amount. In other words, as viewed along the optical axis O as shown in FIG. 6, each swing guide surface 20A, 20B and 20C, which is formed as a portion of a surface of a sphere, and the support surface 42d of the associated support member 42, which is formed as a portion of a surface of a cylinder, are positioned relative to each other so as to overlap each other in the radial direction. Therefore, in a state where all the three support members 42 are positioned at the respective support positions, the three support members 42 impose restrictions on insertion of the movable unit 17 (the barrel holder 12) into the stationary unit (the coil holder 13) in the optical axis direction. Accordingly, it is desirable that the final holding of each support member 42 at the support position as a result of mounting the peripheral enveloping yoke 60 on the coil holder 13 be carried out at least after the movable unit 17 is installed in the stationary unit 18. At a stage before the peripheral enveloping yoke 60 is mounted onto the coil folder 13, each support member 42 is allowed to move radially outwards in the associated through-hole 41, so that the movable unit 17 can be inserted into the stationary unit 18 with each support member 42 retreated radially outwards (with each support member 42 made not to interfere with the swing guide surfaces 20A, 20B and 20C). After the movable unit 17 is inserted into the stationary unit 18, the peripheral enveloping yoke 60 is mounted onto the coil folder 13 to thereby hold each support member 42 at the support position. It is possible for none of the support members 42, the resilient members 43 and the retainer members 44 to be inserted into the through-holes 41 at the stage of inserting the movable unit 17 into the stationary unit 18; in other words, the support members 42, the resilient members 43 and the retainer members 44 may be inserted into the through-holes 41 and subsequently the peripheral enveloping yoke 60 may be mounted onto the coil folder 13 after the insertion of the movable unit 17 into the stationary unit 18.

After the installation of the movable unit 17 in the stationary unit 18 is completed and each support member 42 is held at the support position, the support surface 42d of the support member 42 which projects radially inwards from the thick-walled portion 40A faces against the swing guide surface 20A, the support surface 42d of the support member 42 which projects radially inwards from the thick-walled portion 40B faces against the swing guide surface 20B, and the support surface 42d of the support member 42 which projects radially inwards from the thick-walled portion 40C faces against the swing guide surface 20C, as shown in FIGS. 7 through 9. Due to the swing guide surfaces 20A, 20B and 20C being guided along the support surfaces 42d of the three support members 42, the movable unit 17 (the barrel holder 12) supported in the axial through-portion 13b can perform a spherical-swinging operation, i.e., can spherically swing, relative to the stationary unit 18, about the spherical-swinging center Q (which is the center of a spherical surface in which the swing guide surfaces 20A, 20B and 20C lie).

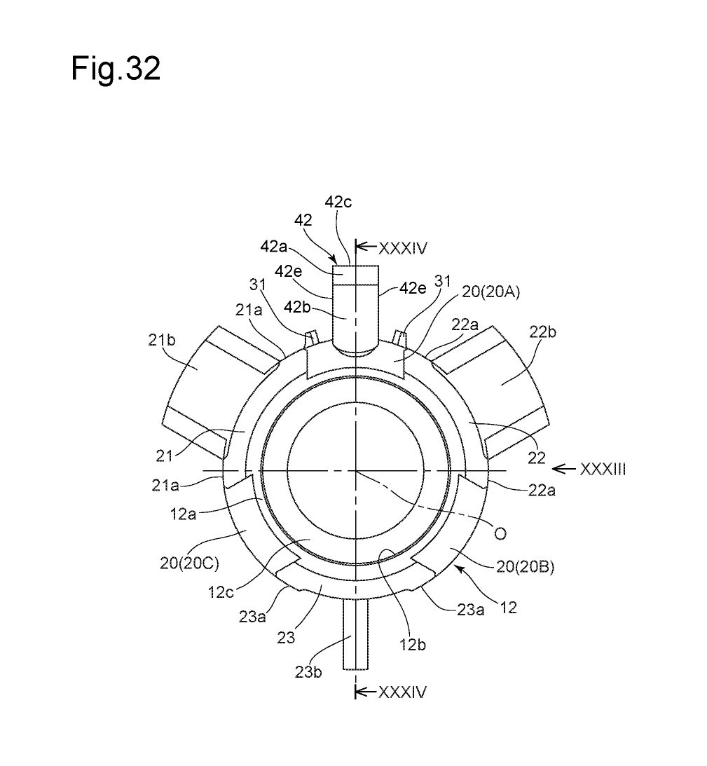

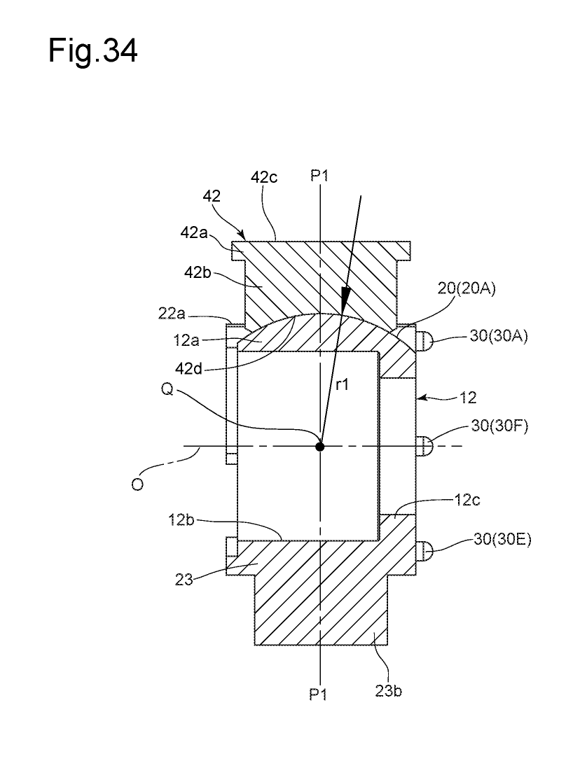

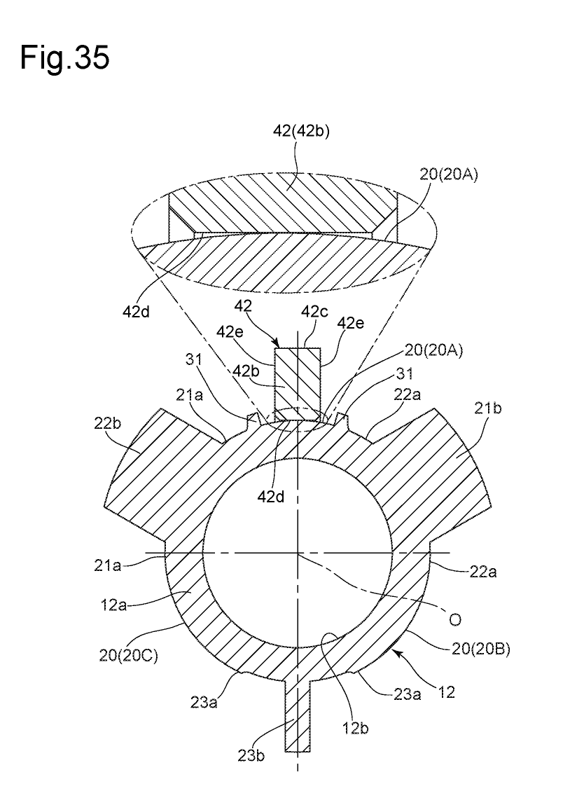

FIGS. 32 through 35 show the relationship between one support member 42 at the support position and the associated swing guide surface 20 (20A). The swing guide surface 20 (20A), which constitutes a portion of a surface of a sphere that is centered on the spherical-swinging center Q, and the support surface 42d of the associated support member 42, which is a portion of a cylindrical surface about a straight line which passes through the spherical-swinging center Q and is substantially orthogonal to the optical axis O, are in line contact with each other along a circular arc that is aligned with the optical axis O. More specifically, as shown in FIG. 34, the support surface 42d has a profile that is defined along a circular arc, having a radius r1 centered on the spherical-swinging center Q, that lies on a cross-sectional plane on which the optical axis O also lies. The radius r1 is substantially identical to the radius of the swing guide surface 20 (20A). On the other hand, as shown in FIG. 35, the support surface 42d has a profile that is defined by a tangent to the swing guide surface 20 (20A) in a cross-sectional plane that is orthogonal (normal) to the optical axis O, and the support surface 42d is in contact with the swing guide surface 20 (20A) only in a point-like manner with respect to the circumferential direction. Accordingly, the swing guide surface 20 (20A) and the support surface 42d of the associated support member 42 are in line contact with each other on a circular arc which is centered on the spherical-swinging center Q on the cross sectional plane shown in FIG. 34 (which passes through the center of the support surface 42d in the circumferential direction and includes the optical axis O).

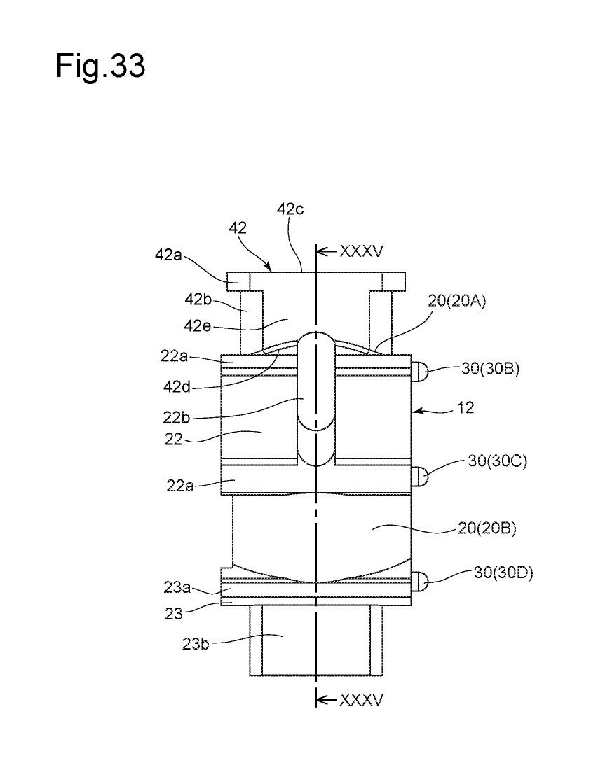

As shown in FIGS. 32 and 35, the swing guide surface 20 (20A) is greater in width in the circumferential direction than the support surface 42d of the associated support member 42. As shown in FIGS. 33 and 34, the range of formation of the swing guide surface 20 (20A) with respect to the optical axis direction is wider than the range of formation of the support surface 42d of the associated support member 42. Therefore, the movable unit 17 (the barrel holder 12) can perform a spherical-swinging operation by a predetermined amount while maintaining a state in which the swing guide surface 20A faces the support surface 42d of the associated support member 42 while maintaining line contact with the support surface 42d along the aforementioned circular arc.

Similar to the swing guide surface 20A shown in FIGS. 32 through 35, each of the swing guide surfaces 20B and 20C can swingably guide the spherical-swinging operation of the movable unit 17 about the spherical-swinging center Q while maintaining line contact with (sliding against) the support surface 42d of the associated support member 42 along a circular arc that is aligned with the optical axis O (and which is centered on the spherical-swinging center Q on a plane including the optical axis O).

The lid member 14 is fixed to the rear end of the axial through-portion 13b of the coil holder 13. As shown in FIGS. 4, 7, 8, 10 and 11, the lid member 14 is in the shape of a disk having a diameter allowing the lid member 14 to be fitted into the inner peripheral portion of the axial through-portion 13b. The lid member 14 is provided with a center opening 14a and a lid portion 14b. The center opening 14a is a circular opening formed at the center of the lid member 14 with respect to the radial direction, and the lid portion 14b is a plate-like portion formed to surround (define) the radially outer periphery of the center opening 14a. The lid member 14 is provided, on the front side of the lid portion 14b in an annular area which surrounds the center opening 14a, with a tilting restriction surface 14c. The lid member 14 is fixed to the coil holder 13 at a position where the front surface of the lid portion 14b comes in contact with the rear end surfaces of the three thick-walled portions 40 (40A, 40B and 40C) as shown in FIGS. 7 and 8. In this state, the tilting restriction surface 14c is a flat surface substantially orthogonal to the optical axis O.

The lens barrel 11 is fitted into the barrel holder 12, which constitutes an element of the movable unit 17, to be fixedly supported by the barrel holder 12. The lens barrel 11 is a cylindrical body which holds an imaging optical system L thereinside (see FIGS. 7 and 8) which includes a plurality of lens elements. As shown in FIGS. 7, 8, 10 and 11, the diameter of the lens barrel 11 changes in a stepwise manner with respect to the optical axis direction. The lens barrel 11 is provided with a large-diameter portion 11a, which is the largest in diameter, at the frontmost end of the lens barrel 11 in the optical axis direction; an intermediate-diameter portion 11b, which is smaller in diameter than the large-diameter portion 11a, behind the large-diameter portion 11a; and a small-diameter portion 11c, which is the smallest in diameter, at the rearmost end of the lens barrel 11 in the optical axis direction.

The lens barrel 11 is inserted into the axial through-portion 12b of the barrel holder 12 from the front with the small-diameter portion 11c facing rearward, and further insertion of the lens barrel 11 into the axial through-portion 12b is prevented by the stepped portion provided between the intermediate portion 11b and the small-diameter portion 11c engaging with the front of the insertion restriction flange 12c of the barrel holder 12 (see FIGS. 7 and 8). In this state, as shown in FIGS. 1, 2, 5, 7 and 8, the small-diameter portion 11c projects rearward from the barrel holder 12 through the insertion restriction flange 12c while the large-diameter portion 11a is positioned in front of the barrel holder 12 in the optical axis direction without being inserted into the axial through-portion 12b. The lens barrel 11 is provided, on the outer peripheral surface of the small-diameter portion 11c that projects rearward from the barrel holder 12, with a peripheral screw (male thread portion) 11d (see FIGS. 7, 8, 10 and 11), and a retainer ring 15 is screwed onto the peripheral screw 11d. The retainer ring 15 is a ring-shaped body provided on the inner peripheral surface thereof with a female screw thread which is screw-engaged with the peripheral screw 11d, and the lens barrel 11 is secured to the barrel holder 12 by tightening the retainer ring 15 until it abuts against the rear surface of the insertion restriction flange 12c. As shown in FIGS. 7 and 8, the center opening 14a of the lid member 14 is greater in diameter than the retainer ring 15, so that the retainer ring 15 is allowed to be attached and detached to and from the small-diameter portion 11c through the center opening 14a after the lid member 14 is mounted to the coil holder 13.

The large-diameter portion 11a of the lens barrel 11 and the barrel holder 12 are larger than the center opening 13d of the front wall 13c of the coil holder 13 in the radial direction (i.e., the large-diameter portion 11a and the barrel holder 12 cannot pass through the center opening 13d in the optical axis direction). Accordingly, the lens barrel 11 is allowed to be inserted into the axial through-portion 13b of the coil holder 13 from the front in the optical axis direction, whereas the barrel holder 12 is allowed to be inserted into the axial through-portion 13b of the coil holder 13 from rear in the optical axis direction. As a procedure of assembling the imaging apparatus 10, the following steps are performed: firstly mounting the lid member 14 to the coil holder 13 after movable unit 17 containing the barrel holder 12 is inserted into the axial through-portion 13b of the coil holder 13 from the rear; subsequently inserting the lens barrel 11 into the axial through-portion 12b of the barrel holder 12 from the front; and thereafter screwing the retainer ring 15 onto the peripheral screw lid through the center opening 14a of the lid member 14 to fix the lens barrel 11 to the barrel holder 12. When the movable unit 17 is installed into the stationary unit 18 (into the coil holder 13), the circumferential position of the movable unit 17 relative to the coil holder 13 is set so that the thick-walled portion 40A (specifically, the projecting portion 42b of the support member 42 that projects radially inwards from the thick-walled portion 40A) is positioned between the pair of rolling-range limit projections 31.

In a state where the lens barrel 11 is inserted into the axial through-portion 12b of the barrel holder 12, the large-diameter portion 11a projects forward from the front of the coil holder 13, and the rear end of the small-diameter portion 11c projects rearward from the rear of the coil holder 13. In this state, an image sensor unit 19 is mounted to the rear end of the small-diameter portion 11c. The lens barrel and the movable unit 17 integrally perform the aforementioned spherical-swinging operation, i.e., an operation in which the lens barrel 11 and the movable unit 17 spherically swing about the spherical-swinging center Q relative to the stationary unit 18. In a state where the image sensor unit 19 is fixed to the rear end of the lens barrel 11, the center of gravity of a movable assembly consisting of the lens barrel 11 and the movable unit 17 substantially coincides with the spherical-swinging center Q.

The image sensor unit 19 is provided with an image sensor 19a (see FIG. 7). The light receiving surface of the image sensor 19a is positioned on the optical axis O and lies orthogonal thereto. An object image obtained through the imaging optical system L is converted into an electrical signal by the image sensor 19a, and the image signal thus obtained is transmitted to a control circuit 35 (conceptually shown in FIG. 7), which controls the overall operation of the imaging apparatus 10, via a flexible wiring board 19b that is connected to the control circuit 35. The control circuit 35 performs an image-signal processing operation to display the object image on a display (not shown) and store the image data in memory. In addition, a signal from an apparatus-attitude detecting sensor 36 (see FIG. 7) which detects the attitude of the imaging apparatus 10 is input to the control circuit 35.

The installation of each coil 54, 55 and 56 and each Hall sensor 57, 58 and 59 to the coil holder 13 can be carried out before the peripheral enveloping yoke 60 is mounted to the coil holder 13. As described above, the coils 54, 55 and 56 are inserted into the through-holes 45, 46 and 47 by fixedly fitting the coil support plates 51, 52 and 53 (to which the coils 54, 55 and 56 are mounted) into the support recesses 48, 49 and 50 with an adhesive or the like, respectively. The inner peripheral surface 54d of the first coil 54 that is exposed to the inside of the axial through-hole 13b of the coil holder 13 through the through-hole 45 is positioned to face the outer peripheral surfaces 27b of the permanent magnets 27-1 and 27-2 of the first magnet unit 27 that constitutes a component of the movable unit 17. Likewise, the inner peripheral surface 55d of the second coil 55 that is exposed to the inside of the axial through-hole 13b of the coil holder 13 through the through-hole 46 is positioned to face the outer peripheral surfaces 28b of the permanent magnets 28-1 and 28-2 of the second magnet unit 28 that constitutes a component of the movable unit 17, and the inner peripheral surface 56d of the third coil 56 that is exposed to the inside of the axial through-hole 13b of the coil holder 13 through the through-hole 47 is positioned to face the outer peripheral surfaces 29b of the permanent magnets 29-1 and 29-2 of the third magnet unit 29 that constitutes a component of the movable unit 17. The first coil 54 and the first magnet unit 27 that radially face each other constitute a first actuator, the second coil 55 and the second magnet unit 28 that radially face each other constitute a second actuator, and the third coil 56 and the third magnet unit 29 that radially face each other constitute a third actuator.

The yoke 24 and the first magnet unit 27 together form a magnetic circuit in the first actuator, the yoke 25 and the second magnet unit 28 together form a magnetic circuit in the second actuator, and the yoke 26 and the third magnet unit 29 together form a magnetic circuit in the third actuator. The yoke 24 surrounds the first magnet unit 27 with the base wall 24a and the pair of standing walls 24b, and the ends of the pair of standing walls 24b are directed toward the coil 54, which is positioned on the radially outside of the yoke 24, to concentrate magnetic field lines of the first magnet unit 27 on the coil 54 side (on the area between the outer peripheral surface 27b and the ends of the pair of standing walls 24b) to thereby amplify the magnetic force acting on the coil 54. Likewise, the yoke 25 surrounds the second magnet unit 28 with the base wall 25a and the pair of standing walls 25b, and the ends of the pair of standing walls 25b are directed toward the coil 55, which is positioned on the radially outside of the yoke 25, to concentrate magnetic field lines of the second magnet unit 28 on the coil 55 side (on the area between the outer peripheral surface 28b and the ends of the pair of standing walls 25b) to thereby amplify the magnetic force acting on the coil 55, and the yoke 26 surrounds the third magnet unit 29 with the base wall 26a and the pair of standing walls 26b, and the ends of the pair of standing walls 26b are directed toward the coil 56, which is positioned on the radially outside of the yoke 26, to concentrate magnetic field lines of the third magnet unit 29 on the coil 56 side (on the area between the outer peripheral surface 29b and the ends of the pair of standing walls 26b) to thereby amplify the magnetic force acting on the coil 56. As mentioned above, the yokes 24, 25 and 26 have the additional capability of holding the magnet units 27, 28 and 29, respectively.

The peripheral enveloping yoke 60, which is made of magnetic material and mounted on the outside of the coil holder 13, also constitutes an element of the magnetic circuit in each actuator. As shown in FIGS. 6 and 9, the peripheral enveloping yoke 60 covers the entire periphery of the cylindrical portion 13a of the coil holder 13, thereby concentrating the magnetic lines of each magnet unit 27, 28 and 29 on the associated coil 54, 55 or 56 and preventing the magnetic flux from leaking outside the imaging apparatus 10.

The Hall sensors 57, 58 and 59 are positioned with a slight clearance from the outer peripheral surfaces 27b, 28b and 29b of the first, second and third magnet units 27, 28 and 29 in the radial direction by installation of the coil support plates 51, 52 and 53 into the sensor support recesses 51b, 52b and 53b, respectively (see FIGS. 7 through 9). Each Hall sensor 57, 58 and 59 is positioned at substantially the center of the associated coil 54, 55 or 56 with respect to the long-side direction and the short-side direction (the center of the outer shape of the associated coil 54, 55 or 56 in a plan view as viewed along a radially-extending straight line) (see FIGS. 7 through 11 and 22 through 27). Variations of the magnetic field in the first actuator (the first magnet unit 27) are detected with the Hall sensor 57, variations of the magnetic field in the second actuator (the second magnet unit 28) are detected with the Hall sensor 58, and variations of the magnetic field in the third actuator (the third magnet unit 29) are detected with the Hall sensor 59. Since the sensor support recesses 51b, 52b and 53b are recessed using the internal spaces of the coil support projections 51a, 52a and 53a that project radially inwards, the Hall sensors 57, 58 and 59 can be disposed in a superior space-efficient manner. In addition, it is possible to enhance the detection accuracy by positioning the Hall sensors 57, 58 and 59 close to the first, second and third magnet units 27, 28 and 29, respectively.

The imaging apparatus 10 is provided on the outer peripheral surfaces of the coil support plates 51, 52 and 53 with a flexible wiring board (not shown). This flexible wiring board is provided with a sensor connecting portion which is connected to the Hall sensors 57, 58 and 59 and a coil connecting portion which is connected to the first, second and third coils 54, 55 and 56 through the through-holes 51c, 52c and 53c, respectively. This flexible wiring board is connected to the control circuit 35 (see FIG. 7) so that magnetic field information obtained from the Hall sensors 57, 58 and 59 is transmitted to the control circuit 35 via this flexible wiring board, and the attitude of the lens barrel 11 that is held by the movable unit 17 is detected based on the aforementioned magnetic field information obtained from the Hall sensors 57, 58 and 59. In addition, the power distribution to the first coil 54, the second coil 55 and the third coil 56 is controlled by the control circuit 35. Although the electrical connections of only the third coil 56 and the Hall sensor 59 to the control circuit 35 are shown in FIG. 7, the first coil 54 and the second coil 55 and the Hall sensors 57 and 58 are also electrically connected to the control circuit 35 in a like manner.

In the first actuator, the longitudinal direction of each long-side portion 54a of the first coil 54 and the longitudinal direction of each permanent magnet 27-1 and 27-2 of the first magnet unit 27 coincide with the circumferential direction, the front long-side portion 54a and the permanent magnet 27-1 radially face each other, and the rear long-side portion 54a and the permanent magnet 27-2 radially face each other. Since each of the permanent magnets 27-1 and 27-2 is magnetized as shown in FIGS. 13 and 15 through 17, energizing the first coil 54 causes a driving force to be generated in either of opposite directions substantially orthogonal to both the direction of the passage of electric current through the pair of long-side portions 54a of the first coil 54 and the direction of the magnetic field of the permanent magnets 27-1 and 27-2 around the pair of long-side portions 54a according to Fleming's left-hand rule. This driving force generated by the first actuator is conceptually shown by arrows F11 and F12 in FIGS. 18 and 21. The direction of action of the driving force is switched between the directions of the arrows F11 and F12 depending on the direction of the passage of electric current through the first coil 54. In the first actuator, the longitudinal direction of the first magnet unit 27 (the permanent magnets 27-1 and 27-2) and the pair of long-side portions 54a of the first coil 54 extend in the circumferential direction, which makes it possible to efficiently generate the driving forces F11 and F12.

In the second actuator, the longitudinal direction of each long-side portion 55a of the second coil 55 and the longitudinal direction of each permanent magnet 28-1 and 28-2 of the second magnet unit 28 substantially align with the circumferential direction, the front long-side portion 55a and the permanent magnet 28-1 radially face each other, and the rear long-side portion 55a and the permanent magnet 28-2 radially face each other. Since each of the permanent magnets 28-1 and 28-2 is magnetized as shown in FIGS. 13 and 15 through 17, energizing the second coil 55 causes a driving force to be generated in either of opposite directions substantially orthogonal to both the direction of the passage of electric current through the pair of long-side portions 55a of the second coil 55 and the direction of the magnetic field of the permanent magnets 28-1 and 28-2 around the pair of long-side portions 55a according to Fleming's left-hand rule. This driving force generated by the second actuator is conceptually shown by arrows F21 and F22 in FIGS. 18 and 20. The direction of action of the driving force is switched between the directions of the arrows F21 and F22 depending on the direction of the passage of electric current through the second coil 55. In the second actuator, the longitudinal direction of the second magnet unit (the permanent magnets 28-1 and 28-2) and the pair of long-side portions 55a of the second coil 55 extend in the circumferential direction, which makes it possible to efficiently generate the driving forces F21 and F22.

In the third actuator, the longitudinal direction of each long-side portion 56a of the third permanent magnet 56 and the longitudinal direction of each permanent magnet 29-1 and 29-2 of the third magnet unit 29 substantially align with the optical axis direction, one of the long-side portions 56a and the permanent magnet 29-1 radially face each other, and the other long-side portion 56a and the permanent magnet 29-2 radially face each other. Since each of the permanent magnets 29-1 and 29-2 is magnetized as shown in FIGS. 13 and 15 through 17, energizing the third coil 56 causes a driving force to be generated in either of opposite directions substantially orthogonal to both the direction of the passage of electric current through the pair of long-side portions 56a of the third coil 56 and the direction of the magnetic field of the permanent magnets 29-1 and 29-2 around the pair of long-side portions 56a according to Fleming's left-hand rule. This driving force generated by the third actuator is conceptually shown by arrows F31 and F32 in FIGS. 19 and 20. The direction of action of the driving force is switched between the directions of the arrows F31 and F32 depending on the direction of the passage of electric current through the third coil 56. In the third actuator, the longitudinal direction of the permanent magnets 29-1 and 29-2 of the third magnet unit 29 and the pair of long-side portions 56a of the third coil 56 extend in the optical axis direction, not the circumferential direction, which makes it possible to efficiently generate the driving forces F31 and F32 in the rolling direction about the optical axis O.

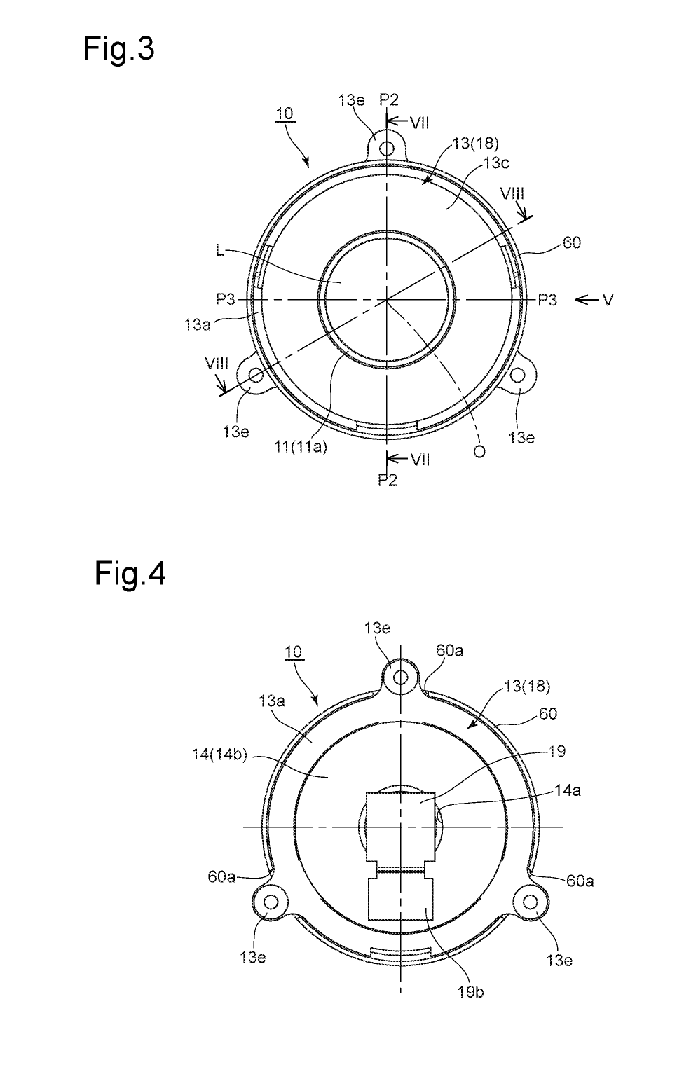

Since each coil 54, 55 and 56 is fixedly supported by the coil holder 13, the driving force of each actuator acts as a force to move the movable unit 17 that includes the first, second and third magnet units 27, 28 and 29. The movable unit 17 is supported to be freely rotatable about the spherical-swinging center Q as described above, and accordingly, the movable unit 17 and the lens barrel 11 integrally perform a tilting operation which tilts (rotates) the optical axis O about the spherical-swinging center Q by the driving forces F11 and F12 of the first actuator and the driving forces F21 and F22 of the second actuator. For instance, with an imaginary plane P2 (shown in FIG. 3) which passes through the midpoint between the first actuator and the second actuator, with respect to the circumferential direction, and includes the optical axis O defined before the optical axis is tilted, with an imaginary plane P3 (shown in FIG. 3) which is orthogonal to the imaginary plane P2 and includes the optical axis O defined before the optical axis is tilted, and upon defining the tilting of the movable unit 17 and the lens barrel 11 along the imaginary plane P2 as integral movement of the movable unit 17 and the lens barrel 11 in the pitching direction and the tilting of the movable unit 17 and the lens barrel 11 along the imaginary plane P3 as integral movement of the movable unit 17 and the lens barrel 11 in the yawing direction, the movable unit 17 and the lens barrel 11 can be made to perform the tilting operation in all directions including the pitching direction and the yawing direction by the driving forces F11 and F12 of the first actuator and the driving forces F21 and F22 of the second actuator.

In addition, the movable unit 17 and the lens barrel 11 can be made to perform a rolling operation, specifically a rotating operation about the optical axis O in the rolling direction (i.e., to vary the angle about the optical axis O in the circumferential direction) by the driving forces F31 and F32 of the third actuator. When the movable unit 17 and the lens barrel 11 are in a tilted state from the initial state thereof due to operations of the first actuator and the second actuator, the rotating operation of the movable unit 17 and the lens barrel 11 is performed by driving force components of the driving forces F31 and F32 of the third actuator in the rotational direction about the optical axis, which is tilted with respect to the coil holder 13.

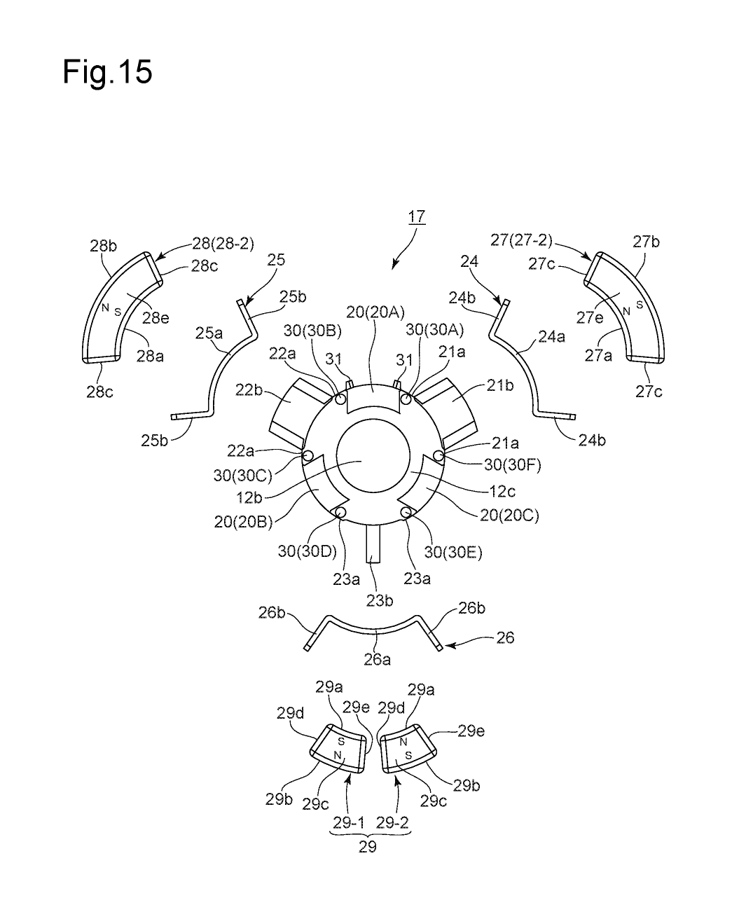

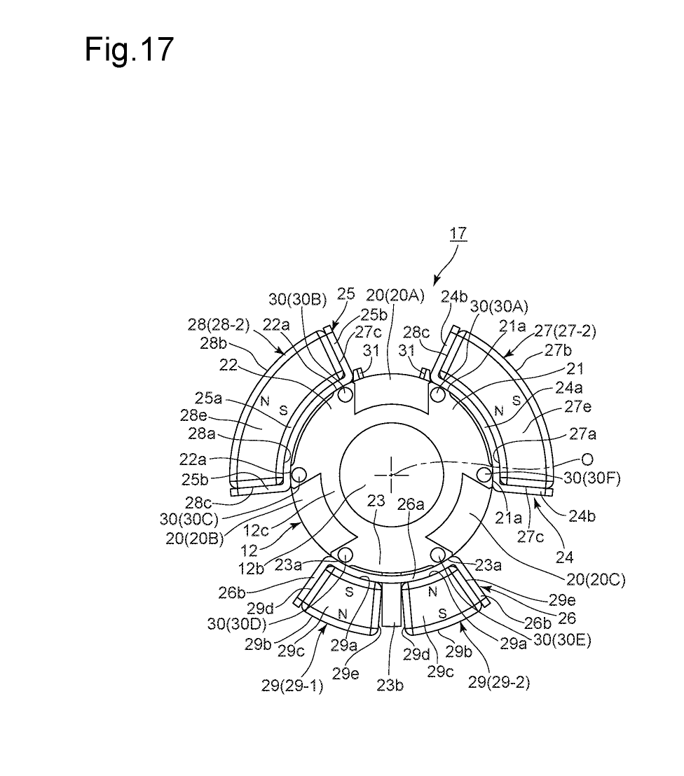

Upon the tilting operation of the movable unit 17 that includes components in the pitching direction and the yawing direction reaching a predetermined amount, one or two of the total of six tilting restriction projections 30A, 30B, 30C, 30D, 30E and 30F that are provided on the barrel holder 12 come into contact with the tilting restriction surface 14c of the lid member 14 to mechanically prevent the movable unit 17 from further tilting. The radial distances of the six tilting restriction projections 30A, 30B, 30C, 30D, 30E and 30F from the optical axis O are substantially the same, and also the positions of the six tilting restriction projections 30A, 30B, 30C, 30D, 30E and 30F with respect to the optical axis direction are the same. Additionally, the distances between the six tilting restriction projections 30A, 30B, 30C, 30D, 30E and 30F in the circumferential direction are substantially the same (i.e., the six tilting restriction projections 30A, 30B, 30C, 30D, 30E and 30F are arranged at substantially equi-angular intervals in the circumferential direction). In other words, as viewed along the optical axis O as shown in FIGS. 15 and 17, connecting the centers between all adjacent pairs of the six tilting restriction projections 30A, 30B, 30C, 30D, 30E and 30F by straight lines forms a regular hexagon. This arrangement of the six tilting restriction projections 30A, 30B, 30C, 30D, 30E makes it possible to restrict the amount of tilting of the movable unit 17 to be substantially uniform, without biasing the amount of tilting of the movable unit 17 to a specific direction. Specifically when the movable unit 17 tilts along a plane which includes the optical axis O and passes through the equidistant point between adjacent two of the six tilting restriction projections 30A, 30B, 30C, 30D, 30E and 30F, both of these adjacent two tilting restriction projections 30 come into contact with the tilting restriction surface 14c. For instance, when the movable unit 17 tilts along a plane which passes through the center of the first coil 54, with respect to the circumferential direction, and includes the optical axis O, the pair of tilting restriction projections 30A and 30F or the pair of tilting restriction projections 30C and 30D come into contact with the tilting restriction surface 14c. When the movable unit 17 tilts along a plane which passes through the center of the second coil 55 in the circumferential direction and includes the optical axis O, the pair of tilting restriction projections 30B and 30C or the pair of tilting restriction projections 30E and 30F come into contact with the tilting restriction surface 14c. When the movable unit 17 tilts along a plane (the imaginary plane P2) which passes through the center of the third coil 56 in the circumferential direction and includes the optical axis O, the pair of tilting restriction projections 30A and 30B or the pair of tilting restriction projections 30D and 30E come into contact with the tilting restriction surface 14c. In any of these states where two of the six tilting restriction projections 30 come into contact with the tilting restriction surface 14c, higher stability and accuracy of the movable unit 17 are achieved than when only one tilting restriction projection 30 comes into contact with the tilting restriction surface 14c, and detection of the tilting operation using the Hall sensors 57, 58 and 59 (especially the Hall sensors 57 and 58) is initialized with reference to the mechanical moving ends (limits) of the above described tilting operations of the movable unit 17 upon, e.g., actuation of the imaging apparatus 10 or upon the anti-shake capability being enabled from a disabled state.

Since variation of magnetic flux density detected using the Hall sensors 57 and 58 is great especially when the movable unit 17 tilts along a plane which passes through the center of the first coil 54, with respect to the circumferential direction, and includes the optical axis O (when the pair of tilting restriction projections 30A and 30F or the pair of tilting restriction projections 30C and 30D come into contact with the tilting restriction surface 14c) and when the movable unit 17 tilts along a plane which passes through the center of the second coil 55, with respect to the circumferential direction, and includes the optical axis O (when the pair of tilting restriction projections 30B and 30C or the pair of tilting restriction projections 30E and 30F come into contact with the tilting restriction surface 14c), it is effective to perform the initialization in the tilting directions along these two planes.

Equal projecting amounts of the six tilting restriction projections 30A, 30B, 30C, 30D, 30E and 30F in the optical axis direction yield the advantage of facilitating the calculation of the amount of movement of the movable unit 17 (the lens barrel 11) and facilitates parts management. However, it is possible to make the projecting amounts of the six tilting restriction projections 30A, 30B, 30C, 30D, 30E and 30F in the optical axis direction mutually different.

When the movable unit 17 rotates in the rolling direction, the range of this rotation is limited by contact of one of the pair of rolling-range limit projections 31 (provided on the swing guide surface 20A of the barrel holder 12) with one of the pair of side surfaces 42e of the support member 42 (the projecting portion 42b) which projects from the thick-walled portion 40A of the coil holder 13 or by contact of the other rolling-range limit projection 31 with the other side surface 42e of the same support member 42 (the projecting portion 42b). As shown in FIGS. 6 and 9, the distance between the pair of rolling-range limit projections 31 in the circumferential direction is greater than the width, with respect to the circumferential direction, of the support member 42 which projects from the thick-walled portion 40A (i.e., the distance between the pair of side surfaces 42e of the same support member 42 in the circumferential direction), and the distance between each rolling-range limit projection 31 and the adjacent side surface 42e of the same support member 42 in the circumferential direction corresponds to the movable amount of the movable unit 17 (the barrel holder 12) in the rolling direction. Upon, e.g., actuation of the imaging apparatus 10 or the anti-shake capability being enabled from a disabled state, an initialization operation of the detection by the Hall sensors 57, 58 and 59 (the Hall sensor 59 in particular) for the rolling operation is carried out with reference to the mechanical moving ends at which one and the other of the pair of rolling-range limit projections 31 respectively come into contact with the pair of side surfaces 42e of the support member 42 (which projects from the thick-walled portion 40A of the coil holder 13).

As described above, the movable unit 17 and the lens barrel 11 can be made to produce motion including rolling, pitching and yawing motion (rotating about the spherical-swinging center Q) flexibly in any rotational direction using the three actuators: the first actuator, the second actuator and the third actuator. This operation of the movable unit 17 and the lens barrel 11 makes it possible to vary the direction of the optical axis O (the inclination of the light receiving surface of the image sensor 19a) and the position of the image sensor 19a in the rotational direction about the optical axis O. For instance, when vibrations caused by hand shake are exerted on the imaging apparatus 10, an anti-shake (image shake correction/image stabilizing/shake reduction) control can be performed in which the movable unit 17 and the lens barrel 11 are integrally moved by an amount and in a direction to reduce image shake on the imagen sensor 19a that is caused by variations in attitude of the imaging apparatus 10 to thereby reduce deterioration of photographed image quality. The anti-shake control is performed by the control circuit 35 controlling the passage of electric current through the first, second and third coils 54, 55 and 56 in accordance with information on the attitude of the imaging apparatus 10 that is obtained using the apparatus-attitude detecting sensor 36 (see FIG. 7) and positional information on the movable unit 17 and the lens barrel 11 that is obtained via the Hall sensors 57, 58 and 59. Specifically, in the present embodiment of the imaging apparatus 10, since the lens barrel 11 that supports the imaging optical system L and the image sensor unit 19 is supported to be rotatable in any rotational direction, it is possible to increase the maximum vibration angle that an image-stabilizing operation can accommodate even though the imaging apparatus 10 is compact in structure compared with a type of imaging apparatus in which an optical system is moved along a plane orthogonal to an optical axis corresponding to the optical axis O. Accordingly, the present embodiment of the imaging apparatus 10 can obtain a superior shake reduction (image-shake correction) effect in not only a camera designed for handheld photography but also an imaging apparatus used under conditions where large image shake tends to occur such as in a wearable camera mountable to any part of the human body or a camera mounted onto a transportation machine such as a motor vehicle.

In addition, since the center of gravity of the movable assembly including the movable unit 17, the lens barrel 11 and the image sensor unit 19 is substantially coincident with the spherical-swinging center Q, load fluctuations caused when the movable unit 17 and the lens barrel 11 are driven are small, and the operation of the movable unit 17 and the lens barrel 11 can be controlled with good responsiveness and high accuracy by the small and light-weight first, second and third actuators.

Additionally, magnetic attractive forces work between the peripheral enveloping yoke 60, which is made of a magnetic metallic material, and the three circular-arc-shaped magnetic units 27, 28 and 29, which are arranged at substantially equi-angular intervals in the circumferential direction, and the movable unit 17 is held at substantially the initial position by the balance between these magnetic attractive forces in a state where no driving force is produced by any of the first, second and third actuators. Accordingly, power consumption for positioning the movable unit 17 at the initial position can be reduced.

In the imaging apparatus 10, the three swing guide surfaces 20A, 20B and 20C, each of which is formed as a portion of the surface of a sphere centered on the spherical-swinging center Q, are provided on the movable unit 17 (the barrel holder 12), and the three support surfaces 42d, each of which is formed as a portion of a concave cylindrical surface centered on the spherical-swinging center Q, are provided on the stationary unit 18 (the coil holder 13), as a structure which supports the movable unit 17 in a manner to allow the movable unit 17 to spherically swing relative to the stationary unit 18.

As described above, in this support structure, the support surface 42d of each support member 42 is in line contact with the associated swing guide surface 20A, 20B or 20C along a circular arc centered on the spherical swing center Q. Therefore, the sliding resistance is small compared with an existing structure which supports a movable unit in a manner to allow the movable unit to spherically swing relative to a stationary unit with a convex spherical surface and a concave spherical surface made in surface contact with each other, which makes it possible to achieve smooth spherical-swinging operation which is small in load on the actuators. In addition, the influence (sensitivity) of accuracy error of parts on operating accuracy is small, which facilitates accuracy control in production and installation of parts.

Additionally, since the load-receiving area is large (long) compared with a structure which supports a movable unit in a manner to allow the movable unit to spherically swing relative to a stationary unit with a spherical body made in contact (point contact) with a convex spherical surface, deformation and damage (e.g., dents or pockmarks on the swing guide surfaces 20A, 20B and 20C) which may be caused by locally concentrated load between each swing guide surface 20A, 20B and 20C and the support surface 42d of the associated support member 42 do not easily occur upon a strong impact being applied to the imaging apparatus 10, which makes it possible to achieve excellent shock resistance and high durability.

Additionally, in such a structure in which a spherical body is made to come into point contact with a convex spherical surface, it is often the case that a plurality of balls (spherical bodies) are aligned per one position, with respect to the circumferential direction to achieve stability of support. Therefore, the dimensional accuracy and the positional accuracy of the plurality of balls tends to vary, so that the degree of difficulty in controlling the accuracy of the support structure is high. Whereas, each support surface 42d is formed on one support member 42, provided as a single member, and accordingly, it is easy to control the accuracy of the support structure compared with a structure in which a plurality of balls are aligned. In terms of ease of assembly also, the structure in which single support members (42) are inserted into the coil holder 13 is superior to a structure in which a plurality of balls are arranged and held.

Additionally, each support member 42, which has one support surface 42d, is movable radially outwards away from the associated swing guide surface 20A, 20B or 20C against the biasing force of the associated resilient member 43, and shock can be absorbed by radially outward movements of each support member 42 and deformation of each resilient member 43. When any one support member 42 is at the support position, an extremely small amount of clearance that is sufficiently small so as not to cause the movable unit 17 to rattle is provided between this support surface 42d and the associated swing guide surface 20A, 20B or 20C. Therefore, the biasing force of each resilient member 43 works as a force which presses the flange 42a of the associated support member 42 against the restricting surface 41d in the associated through-hole 41 and does not act as a force which presses the support surface 42d of the associated support member 42 against the associated swing guide surface 20A, 20B or 20C, which enables the movable unit 17 to spherically swing smoothly while reducing the load on the actuators.

The three combinations of the support members 42, the resilient members 43 and the retainer members 44, which are elements of the support structure that movably supports the movable unit 17, and the three actuators (the first, second and third actuators) for anti-shake driving operation are alternately arranged in the circumferential direction (see FIG. 9) and housed around the imaging optical system L in a space-efficient manner. Additionally, since one support member 42, one resilient member 43 and one retainer member 44 are inserted into each through-hole 41, which radially extends through the coil holder 13, from the radially outer side of the coil holder 13, the imaging apparatus 10 is superior also in workability of assembling and maintaining the imaging apparatus 10 even though the support structure that movably supports the movable unit 17 is structured such that the three swing guide surfaces 20A, 20B and 20C and the three support surfaces 42d are positioned in a radially deep part of the imaging apparatus 10 in the vicinity of the spherical swing center Q.

In addition, the three support members 42, the three resilient members 43 and the three retainer members 44 that are inserted into the three through-holes 41 are prevented from coming off radially outwards therefrom to be held therein by the peripheral enveloping yoke 60. The peripheral enveloping yoke 60 is a cylindrical body made of metal, thus superior in rigidity. Therefore, even if the biasing force of one or more of the resilient members 43 or an impulsive force tending to sporadically press one or more of the support members 42 radially outwards is exerted on the peripheral enveloping yoke 60 from the associated retainer member or members 44, the peripheral enveloping yoke 60 is not easily deformed, which contributes to high-precision and stable holding of the support members 42. The peripheral surrounding yoke 60 further contributes also to improvement in rigidity of the whole of the imaging apparatus 10 that includes the coil holder 13.

Additionally, upon assembling the imaging apparatus 10, since each support member 42 can be held at the support position by simultaneously pressing the three retainer members 44 radially inwards by relative movement between the peripheral enveloping yoke 60 and the coil holder 13 in the optical axis direction, such a structure which prevents each retainer member 44 from coming off using the peripheral enveloping yoke 60 is superior also in workability during assembly.

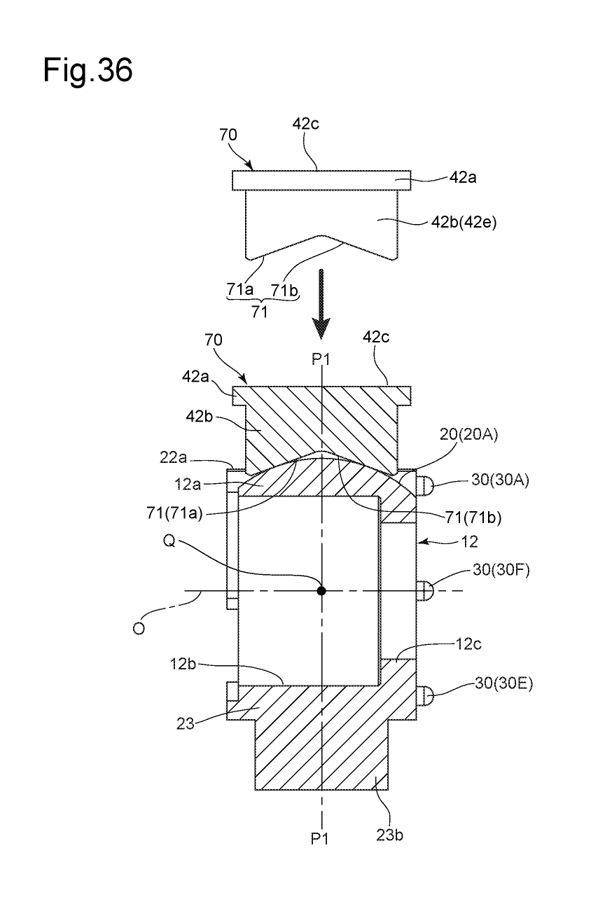

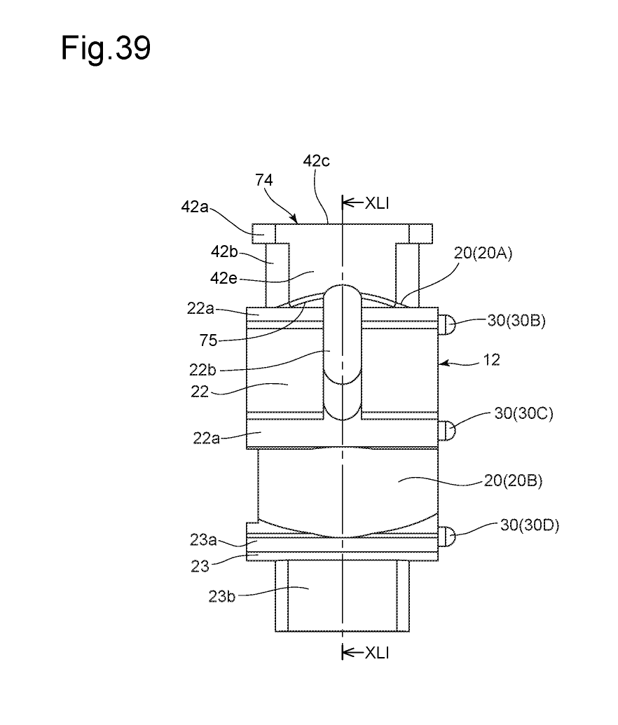

FIGS. 36 through 41 show other embodiments (second through fourth embodiments) according to the present invention. In each of these embodiments, the support surface formed on each support member that is provided in the stationary unit 18 is formed having a different shape from the shape of the support surface 42d of each support member 42. Elements in each of these embodiments which are similar to those in the above described first embodiment are designated by the same reference numerals and the descriptions about such elements will be omitted from the following description. In each of the second through fourth embodiments that will be discussed below, only one support member (70, 72 or 74) which comes in contact with the swing guide surface 20A is illustrated; however, similar to the above described embodiment of the imaging apparatus 10, a total of three support members are provided at three different positions in the circumferential direction in each of the second through fourth embodiments.

The support member (supporter) 70 shown in FIG. 36, provided as an element of the second embodiment of the imaging apparatus, is provided at the radially inner end (the lower end with respect to FIG. 36) with a support surface (supporter) 71. The support surface 71 is formed from a first flat surface portion 71a and a second flat surface portion 71b. The first flat surface portion 71a is a flat surface which is inclined radially outwards in the direction from front to rear in the optical axis direction (from left to right with respect to FIG. 36), while the second flat surface portion 71b is a flat surface which is inclined radially outwards in the direction from rear to front in the optical axis direction (from right to left with respect to FIG. 36). The radially outermost ends of the first flat surface portion 71a and the second surface portion 71b meet at the imaginary plane P1. The first flat surface portion 71a and the second flat surface portion 71b are substantially symmetrical in shape with respect to the imaginary plane P1.

In a state where the support member 70 shown in FIG. 36 is at the support position in the associated through-hole 41 of the coil holder 13, the first flat surface portion 71a and the second flat surface portion 71b are in slidable contact with the associated swing guide surface 20 (20A) at positions in front of and behind the imaginary plane P1, respectively, as shown in the cross section shown in a substantially lower half of FIG. 36. In other words, the first flat surface portion 71a and the second flat surface portion 71b are in slidable contact with the associated swing guide surface 20 (20A) at different points with respect to an optical axis direction. The support member 70 shown in FIG. 36, together with the remaining two support members 70 not shown in FIG. 36, supports the barrel holder 12 via these two contact portions in a manner to allow the barrel holder 12 to spherically rotate, i.e., perform the spherical-swinging operation.

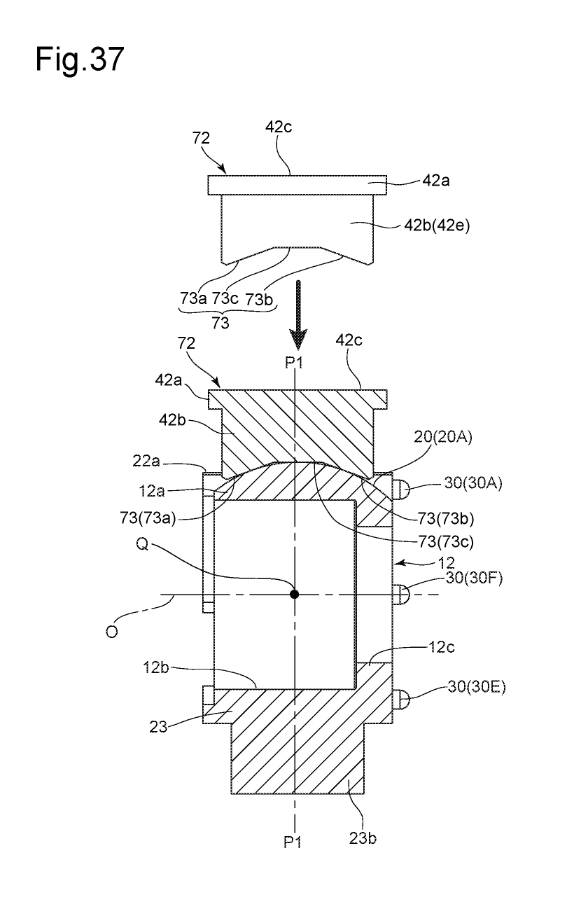

The support member (supporter) 72 shown in FIG. 37, provided as an element of the third embodiment of the imaging apparatus, is provided at the radially inner end (the lower end with respect to FIG. 37) with a support surface (supporter) 73. The support surface 73 is formed from a first flat surface portion 73a, a second flat surface portion 73b and a third flat portion 73c. The first flat surface portion 73a is a flat surface which is inclined radially outwards in the direction from front to rear in the optical axis direction (from left to right with respect to FIG. 37), while the second flat surface portion 73b is a flat surface which is inclined radially outwards in the direction from rear to front in the optical axis direction (from right to left with respect to FIG. 37). The third flat portion 73c is a flat surface which is substantially parallel to the optical axis O and substantially orthogonal to the imaginary plane P1. The center of the third flat portion 73c in the optical axis direction lies on the imaginary plane P1. The first flat surface portion 73a and the second surface portion 73b are substantially symmetrical in with respect to the imaginary plane P1.

In a state where the support member 72 shown in FIG. 37 is at the support position in the associated through-hole 41 of the coil holder 13, the first flat surface portion 73a and the second flat surface portion 73b are in slidable contact with the associated swing guide surface 20 (20A) at positions in front of and behind the imaginary plane P1, respectively, while the third flat surface portion 73c is in slidable contact with the associated swing guide surface 20 (20A) at a position nearly on the imaginary plane P1. In other words, the first flat surface portion 73a, the second flat surface portion 73b and the third flat surface portion 73c are in slidable contact with the associated swing guide surface 20 (20A) at different points with respect to an optical axis direction. The support member 72 shown in FIG. 37, together with the remaining two support members 72 not shown in FIG. 37, supports the barrel holder 12 via these three contact portions in a manner to allow the barrel holder 12 to spherically rotate, i.e., perform the spherical-swinging operation.

The structure in which each swing guide surface 20 (20A, 20B and 20C) that is shaped into a spherical surface is supported by the associated support surface (71 or 73) having a plurality of flat surface portions (71a and 71b, or 73a, 73b and 73c), like the support member 70 of the second embodiment shown in FIG. 36 or the support member 72 of the third embodiment shown in FIG. 37, can also obtain a similar effect to the support member 42 of the first embodiment of the imaging apparatus 10. Unlike the support surface 42d of each support member 42 that is in contact with the associated swing guide surface 20 in a circular arc line-shaped area, each of the flat surface portions 71a and 71b of the support surface 71 is in contact with the associated swing guide surface 20 in a narrow point-like area in the second embodiment shown in FIG. 36, and each of the flat surface portions 73a, 73b and 73c of the support surface 73 is in contact with the associated swing guide surface 20 in a narrow point-like area in the third embodiment shown in FIG. 37. However, compared with the structure in which balls are brought into contact with the swing guide surfaces 20, the structure of the second embodiment shown in FIG. 36 and the structure of the third embodiment shown in FIG. 37 are superior in shock resistance and durability because local load concentration does not easily occur. In addition, accuracy control is easy compared with the structure in which concave spherical surfaces or balls are made into contact with the swing guide surfaces 20; moreover, smooth spherical-swinging operation with less sliding resistance can be achieved. For instance, since each support member 70 is provided thereon with the first flat surface portion 71a and the second flat surface portion 71b in the second embodiment and each support member 72 is provided thereon with the first flat surface portion 73a, the second flat surface portion 73b and the third flat surface 73c in the third embodiment, the accuracy of relative positions between the flat surface portions 71a and 71b, or 73a, 73b and 73c at the stage of installation does not vary, which makes it possible to easily achieve high-precision support compared with the structure in which a plurality of balls are individually arranged in the optical axis direction. Moreover, there is no need to prepare a plurality of balls in each of the second and third embodiments, which is advantageous also for production cost.

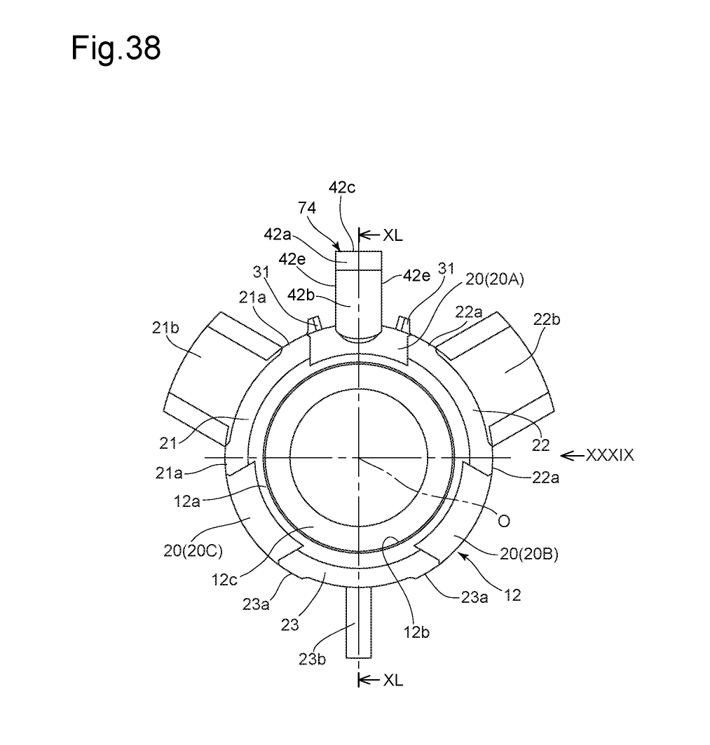

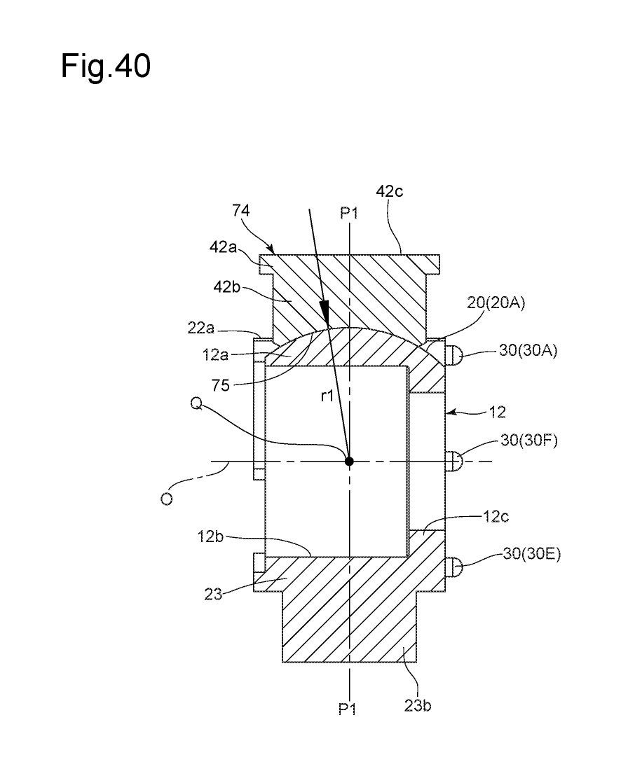

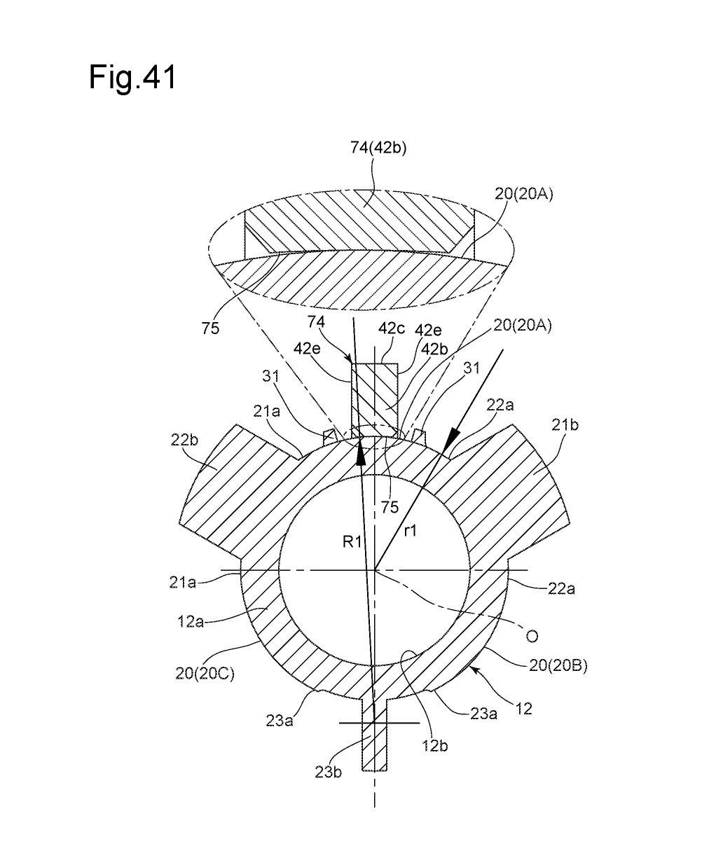

The support member (supporter) 74 shown in FIGS. 38 through 41, provided as an element of the fourth embodiment of the imaging apparatus, is provided at the radially inner end (the lower end with respect to FIGS. 38 through 41) with a support surface (supporter) 75. The support surface 75 is formed as a concave curved surface (part of a torus) whose radius (radius of curvature) varies depending on the direction. More specifically, the support surface 75 has a shape extending along a circular arc with a radius r1 which is centered on the spherical-swinging center Q in the cross section shown in FIG. 40 that includes the optical axis O, and the radius r1 coincides with the radius of the swing guide surface 20 (20A). Accordingly, in the cross section shown in FIG. 40 (a plane including the optical axis O), the shape of the support surface 75 substantially matches the shape of the support surface 42d of the support member 42 of the first embodiment of the imaging apparatus. On the other hand, as shown in FIG. 41, in a plane orthogonal to the optical axis O (i.e., in the imaginary plane P1), the support surface 75 has a shape extending along a circular arc with a radius R1 which is centered on the spherical-swinging center Q and greater than the radius r1. Therefore, as shown in the enlarged view in FIG. 41, in the plane orthogonal to the optical axis O, the support surface 75 is smaller in curvature than the swing guide surface 20 (20A) and comes in contact with the swing guide surface 20 (20A) only at a specific point (in the plane orthogonal to the optical axis O) with respect to the circumferential direction.

As described above, the support surface 75 of each support member 74 has substantially the same curvature as the swing guide surface 20 (20A) in the imaginary plane (the imaginary plane P2 shown in FIG. 3) that includes the optical axis O, while the support surface 75 of each support member 74 is in the shape of a curved surface with a smaller curvature than the swing guide surface 20 (20A) in the imaginary plane P1 that is orthogonal (normal) to the optical axis O (orthogonal to both imaginary planes P2 and P3 shown in FIG. 3). Accordingly, similar to the support surface 42d of each support member 42 of the first embodiment, the support surface 75 of each support member 74 is in line contact with the swing guide surface 20 (20A) along a circular arc that is aligned with the optical axis O, and the support surface 75 of each support member 74 has a small sliding resistance and easily exhibits excellent accuracy control compared with a structure in which spherical surfaces are made into contact with each other, and advantageous in shock resistance and productivity compared with a structure in which balls are brought into contact with spherical surfaces.

As can be seen from a comparison of FIGS. 35 and 41, the distance between the swing guide surface 20 (20A) and each of two circumferentially-spaced noncontact surface portions of the support surface 75 of each support member 74, positioned on opposite sides of the center of the support surface 75 in the circumferential direction, is smaller than that between the swing guide surface 20 (20A) and each of two circumferentially-spaced noncontact surface portions of the support surface 42d of each support member 42. Due to this difference, the support surface 42d of each support member 42 is slightly more advantageous in reduction of sliding resistance on the swing guide surface 20 (20A) than the support surface 75 of each support member 74, whereas the support surface 75 of each support member 74 is slightly more advantageous in shock resistance than the support surface 42d of each support member 42.

Although the present invention has been described based on the above illustrated embodiments, the present invention is not limited solely thereto; various modifications to the above illustrated embodiment are possible without departing from the scope of the invention. For instance, in the present embodiments, the three swing guide surfaces 20A, 20B and 20C that are provided on the barrel holder 12 are portions of the surface of a sphere centered on the spherical-swinging center Q (the three swing guide surfaces 20A, 20B and 20C, which are centered on the spherical-swinging center Q, are identical in radius of curvature); however, instead of the three swing guide surfaces 20A, 20B and 20C, three spherical surfaces which are centered on spherical-swinging center Q and mutually different in radius of curvature can be made as supported surfaces on the barrel holder 12 side. In this case, the support surfaces (42d, 71, 73 or 75) of the three support members (42, 70, 72 or 74) provided on the coil holder 13 are configured to have shapes corresponding to the different curvature radii of the three spherical surfaces (supported surfaces).

Each of the above described embodiments is provided with the three swing guide surfaces 20A, 20B and 20C, which are formed at different positions in the circumferential direction, and the three support surfaces 42d (or 71, 73 or 75), which are formed at different positions in the circumferential direction, as a support structure for spherical-swinging operation (i.e., the aforementioned support structure that supports the movable unit 17 in a manner to allow the barrel holder 12 to spherically swing). In the case where the barrel holder 12 is supported at a plurality of support points in the circumferential direction to be capable of spherically rotation, if the number of the support points in the circumferential direction is two or smaller than two, the position of the barrel holder 12 in a plane orthogonal to the optical axis O is not fixed, which cannot achieve the support structure. Additionally, if the number of the support points in the circumferential direction is four or greater, there is a possibility of the position of the barrel holder 12 becoming unstable depending on mutual accuracy error. Accordingly, it is ideal that the number of the support points in the circumferential direction be three as in each of the above described embodiments. However, each support member (42, 70, 72 and 74) of the above described embodiments can absorb a margin of error while resiliently deforming the associated resilient member 43, which makes it possible to set the number of the support points to four or greater with substantially no loss of stability.

In the case where the number of the support points in the circumferential direction is set to three, it is desirable that the three swing guide surfaces 20A, 20B and 20C be arranged at substantially equally-spaced intervals (intervals of 120 degrees) and that the three support surfaces 42d (or 71, 73 or 75) be arranged at substantially equally-spaced intervals (intervals of 120 degrees) as in the above described embodiments. However, by setting the intervals between the supported surfaces on the movable member side (the barrel holder 12 side) in the circumferential direction and the intervals between the support surfaces on the stationary member side (the coil holder 13 side) to an angle in the range from 30 to 150 degrees, stability and precision required for the support structure for spherical-swinging operation can be ensured, so that the barrel holder 12 can also be supported at support points at intervals other than intervals of 120 degrees in the circumferential direction. The intervals between the supported surfaces are set with reference to the centers of the supported surfaces in the circumferential direction and the intervals between the support surfaces are set with reference to the centers of the support surfaces in the circumferential direction.

Although the peripheral enveloping yoke 60 serves as a retainer for the retainer members 44 while also serving as a yoke (magnetic material) which surrounds the actuators (the first, second and third actuators) in the above illustrated embodiments, the peripheral enveloping yoke 60 can be made of a nonmagnetic material to serve only as a retainer for the retainer members 44.

Specific structures of the actuators for anti-shake driving operation are not limited to the particular structures of the above illustrated embodiments and can be any other structure. For instance, although the above illustrated embodiment of the imaging apparatus 10 uses voice coil motors (VCMs) as drivers for use in an anti-shake driving operation, any other type of driver other than voice coil motors can be adopted. In addition, the above illustrated embodiment of the imaging apparatus 10 incorporates moving-magnet type voice coil motors, in which magnets and yokes are supported on a movable member (the barrel holder 12) which moves during anti-shake driving operation while coils are supported on a stationary member (the coil holder 13) which does not move during anti-shake driving operation. However, an imaging apparatus according to the present invention can also use moving-coil type voice coil motors in which magnets and coils are inversely arranged, i.e., in which magnets (and yokes) are supported on the stationary member while coils are supported on the movable member.

In the above illustrated embodiment of the imaging apparatus 10, the whole of the imaging device which contains the imaging optical system L and the image sensor unit 19 is made to perform a tilting operation and a rolling operation; however, the present invention can also be applied to a type of imaging apparatus which performs an image-stabilizing operation by moving only a portion (a lens element or a lens group) of the imaging optical system L or the image sensor 19a.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An imaging apparatus comprising:
a movable member configured to support at least a part of an imaging device for obtaining object images;
a supporter configured to support said movable member in a manner to allow said movable member to spherically swing relative to a stationary member about a swing center on an optical axis of an optical system of said imaging device; and
a driver configured to apply a driving force to said movable member to make said movable member spherically swing relative to said stationary member, about the swing center, to perform an image-stabilizing operation,
wherein said supporter includes:
supported surfaces formed on said movable member at different positions with respect to a circumferential direction about said optical axis in an initial state, in which said movable member is positioned at an initial position of said spherical-swinging operation with respect to said stationary member, each said supported surface defining a portion of a spherical surface centered about said swing center; and
support surfaces provided on said stationary member at different positions in said circumferential direction about said optical axis in said initial state, said supported surfaces being in slidable contact with said support surfaces, each said support surface defining a portion of a surface of a cylinder having a central axis that passes through said swing center in a direction substantially orthogonal to said optical axis in said initial state, said cylinder having substantially the same radius as that of the spherical surface of an associated supported surface.

2. An imaging apparatus comprising:
a movable member configured to support at least a part of an imaging device for obtaining object images;
a supporter configured to support said movable member in a manner to allow said movable member to spherically swing relative to a stationary member about a swing center on an optical axis of an optical system of said imaging device; and
a driver configured to apply a driving force to said movable member to make said movable member spherically swing relative to said stationary member, about the swing center, to perform an image-stabilizing operation,
wherein said supporter includes:
supported surfaces formed on said movable member at different positions with respect to a circumferential direction about said optical axis in an initial state, in which said movable member is positioned at an initial position of said spherical-swinging operation with respect to said stationary member, each said supported surface defining a portion of a spherical surface centered about said swing center; and
support surfaces provided on said stationary member at different positions in said circumferential direction about said optical axis in said initial state, each said support surface including flat surface portions which are in slidable contact with associated one of said supported surfaces at different points in a direction of said optical axis in said initial state.

3. The imaging apparatus according to claim 2, wherein said flat surface portions of each said support surface comprise a pair of flat surface portions which are positioned substantially symmetrically with respect to a plane which passes through said swing center and is substantially orthogonal to said optical axis in said initial state.

4. The imaging apparatus according to claim 3, wherein said flat surface portions of each said support surfaces further comprise a third flat surface portion which is substantially parallel to said optical axis in said initial state and connects said pair of flat surface portions.

5. An imaging apparatus comprising:
a movable member configured to support at least a part of an imaging device for obtaining object images;
a supporter configured to support said movable member in a manner to allow said movable member to spherically swing relative to a stationary member about a swing center on an optical axis of an optical system of said imaging device; and
a driver configured to apply a driving force to said movable member to make said movable member spherically swing relative to said stationary member, about the swing center, to perform an image-stabilizing operation,
wherein said supporter includes:
supported surfaces formed on said movable member at different positions with respect to a circumferential direction about said optical axis in an initial state, in which said movable member is positioned at an initial position of said spherical-swinging operation with respect to said stationary member, each said supported surface defining a portion of a spherical surface centered about said swing center; and
support surfaces provided on said stationary member at different positions in said circumferential direction about said optical axis in said initial state, said supported surfaces being in slidable contact with said support surfaces, each said support surface defining a portion of a torus, said torus having a circular arc shape having substantially the same radius as that of the spherical surface of an associated supported surface in a plane including said optical axis in said initial state, and a circular arc shape having a greater radius than that of the spherical surface of said associated supported surface in a plane substantially orthogonal to said optical axis in said initial state.

6. The imaging apparatus according to claim 1, wherein three of said supported surfaces are provided at different circumferential positions about said optical axis, and three of said support surfaces are provided at positions corresponding to said different circumferential positions about said optical axis, wherein an interval between each of said different circumferential positions is within an angular range of 30° through 150° about said optical axis.

7. The imaging apparatus according to claim 2, wherein three of said supported surfaces are provided at different circumferential positions about said optical axis, and three of said support surfaces are provided at positions corresponding to said different circumferential positions about said optical axis, wherein an interval between each of said different circumferential positions is within an angular range of 30° through 150° about said optical axis.

8. The imaging apparatus according to claim 5, wherein three of said supported surfaces are provided at different circumferential positions about said optical axis, and three of said support surfaces are provided at positions corresponding to said different circumferential positions about said optical axis, wherein an interval between each of said different circumferential positions is within an angular range of 30° through 150° about said optical axis.

9. The imaging apparatus according to claim 1, wherein said supporter comprises:
support members which are supported to be movable relative to said stationary member in a radial direction with respect to said optical axis in said initial state, said support member respectively provided with said support surfaces at radially inner ends in said radial direction;
restrictors provided on said stationary member and each said support members to restrict radially inward movements of said support members beyond a support position at which said support surfaces support said supported surfaces in a manner to allow said movable member to spherically swing relative to said stationary member; and
shock absorbers which bias said support members radially inwards to hold said support members at said support position and which absorb a load when said support members move radially outwards from said support position.

10. The imaging apparatus according to claim 2, wherein said supporter comprises:
support members which are supported to be movable relative to said stationary member in a radial direction with respect to said optical axis in said initial state, said support member respectively provided with said support surfaces at radially inner ends in said radial direction;
restrictors provided on said stationary member and each said support members to restrict radially inward movements of said support members beyond a support position at which said support surfaces support said supported surfaces in a manner to allow said movable member to spherically swing relative to said stationary member; and
shock absorbers which bias said support members radially inwards to hold said support members at said support position and which absorb a load when said support members move radially outwards from said support position.

11. The imaging apparatus according to claim 5, wherein said supporter comprises:
support members which are supported to be movable relative to said stationary member in a radial direction with respect to said optical axis in said initial state, said support member respectively provided with said support surfaces at radially inner ends in said radial direction;
restrictors provided on said stationary member and each said support members to restrict radially inward movements of said support members beyond a support position at which said support surfaces support said supported surfaces in a manner to allow said movable member to spherically swing relative to said stationary member; and
shock absorbers which bias said support members radially inwards to hold said support members at said support position and which absorb a load when said support members move radially outwards from said support position.

12. The imaging apparatus according to claim 9, wherein said supporter comprises:
retainers which are positioned radially outside said support members, respectively, and supported to be movable relative to said stationary member in said radial direction; and
an outer restricting portion which prevents said retainers from coming off radially outwards from said stationary member, and
wherein said shock absorbers are held between said support members and said retainers and are made of a resilient material.

13. The imaging apparatus according to claim 10, wherein said supporter comprises:
retainers which are positioned radially outside said support members, respectively, and supported to be movable relative to said stationary member in said radial direction; and
an outer restricting portion which prevents said retainers from coming off radially outwards from said stationary member, and
wherein said shock absorbers are held between said support members and said retainers and are made of a resilient material.

14. The imaging apparatus according to claim 11, wherein said supporter comprises:
retainers which are positioned radially outside said support members, respectively, and supported to be movable relative to said stationary member in said radial direction; and
an outer restricting portion which prevents said retainers from coming off radially outwards from said stationary member, and
wherein said shock absorbers are held between said support members and said retainers and are made of a resilient material.

15. The imaging apparatus according to claim 12, wherein said stationary member comprises a cylindrical portion centered on said optical axis in said initial state,
wherein said support members, said resilient members and said retainers are respectively positioned in through-holes which are formed through said cylindrical portion of said stationary member in said radial direction, and
wherein said outer restricting portion includes a peripheral enveloping member which is supported outside said cylindrical portion of said stationary member to cover radially outer end openings of said through-holes.

16. The imaging apparatus according to claim 13, wherein said stationary member comprises a cylindrical portion centered on said optical axis in said initial state,
wherein said support members, said resilient members and said retainers are respectively positioned in through-holes which are formed through said cylindrical portion of said stationary member in said radial direction, and
wherein said outer restricting portion includes a peripheral enveloping member which is supported outside said cylindrical portion of said stationary member to cover radially outer end openings of said through-holes.

17. The imaging apparatus according to claim 14, wherein said stationary member comprises a cylindrical portion centered on said optical axis in said initial state,
wherein said support members, said resilient members and said retainers are respectively positioned in through-holes which are formed through said cylindrical portion of said stationary member in said radial direction, and
wherein said outer restricting portion includes a peripheral enveloping member which is supported outside said cylindrical portion of said stationary member to cover radially outer end openings of said through-holes.

18. The imaging apparatus according to claim 15, wherein each of said retainers comprises a guide surface which produces a component of force that moves said each retainer radially inwards upon receiving a force in said optical axis direction in said initial state from said peripheral enveloping member.

19. The imaging apparatus according to claim 16, wherein each of said retainers comprises a guide surface which produces a component of force that moves said each retainer radially inwards upon receiving a force in said optical axis direction in said initial state from said peripheral enveloping member.

20. The imaging apparatus according to claim 17, wherein each of said retainers comprises a guide surface which produces a component of force that moves said each retainer radially inwards upon receiving a force in said optical axis direction in said initial state from said peripheral enveloping member.

21. The imaging apparatus according to claim 1, wherein said driver comprises actuators respectively provided between said supported surfaces and said support surfaces at circumferential positions about said optical axis.

22. The imaging apparatus according to claim 2, wherein said driver comprises actuators respectively provided between said supported surfaces and said support surfaces at circumferential positions about said optical axis.

23. The imaging apparatus according to claim 5, wherein said driver comprises actuators respectively provided between said supported surfaces and said support surfaces at circumferential positions about said optical axis.
